(19) United States
(12) Patent Application Publication
(10) Pub. No.: US 2012/0133762 A1
(43) Pub. Date: May 31, 2012

(54) METHOD AND SYSTEM FOR DETECTING AND CLASSIFYING A DEFECT OF A SUBSTRATE

(75) Inventors: Jean-Philippe Schweitzer, Shanghai (CN); Huifen Li, Shanghai (CN); Xiaofeng Lin, Shanghai (CN); Xiaofeng Guo, Shanghai (CN); Feng Guo, Shanghai (CN); Xiaowei Sun, Shanghai (CN)

(73) Assignee: SAINT-GOBAIN GLASS FRANCE, F-92400 Courbevoie (FR)

(21) Appl. No.: 13/384,909

(22) PCT Filed: Feb. 26, 2010
(86) PCT No.: PCT/CN2010/070791

§ 371 Date: Jan. 19, 2012

(30) Foreign Application Priority Data
Jul. 31, 2009 (CN) 200910161107.3
Nov. 27, 2009 (CN) 200910246381.0

(51) Int. Cl. H04N 7/18

(52) U.S. Cl. 348/92; 348/E07.085

(57) ABSTRACT

A method and system for detecting and classifying a defect of a substrate, the system including a first channel, including a first illuminating unit to irradiate a light to a substrate and a first imaging unit to take images by sensing a light from the substrate when it is irradiated; a second channel, including a second illuminating unit to irradiate a light to the substrate and a second imaging unit to take images by sensing a light from the substrate when it is irradiated; an image constructing module to construct two images of the substrate using the images of the first and second imaging units respectively; and an image processing module to detect, when the substrate has a defect, that the defect is a defect on or in the substrate, based on a relationship of positions where the defect of the substrate appears in the two images of the substrate.

The present application claims priorities of Chinese patent application No. 200910161107.3 filed on Jul. 31, 2009 and Chinese patent application No. 200910246381.0 filed on Nov. 27, 2009. All the contents of the two Chinese patent applications are incorporated herein by reference.

### TECHNICAL FIELD

The present invention relates to a method and system for detecting and classifying a defect of a substrate.

### BACKGROUND ART

At present, many fields use a transparent or semi-transparent substrate, e.g., a substrate with patterns or structures used in a photovoltaic cell or a photovoltaic module in the solar module industry. In the process of manufacturing, the transparent or semi-transparent substrate will produce a variety of defects, for example, scratch, smudge and open bubble located on a surface of the substrate, and close bubble and calculus (black stone, white stone and stones of other colors) located inside the substrate. The prior art has proposed many defect checking solutions for checking a defect of the transparent or semi-transparent substrate.

However, as the requirement of quality of the transparent or semi-transparent substrate is becoming higher, quality control standards for different types of defects are needed. Under this condition, not only detecting a defect of the transparent or semi-transparent substrate but also differentiating whether the detected defect is located on the substrate or in the substrate is needed.

### SUMMARY

Embodiments of the present invention provide a method and system for detecting and classifying a defect of a substrate, which can detect and classify a defect of a transparent or semi-transparent substrate.

A system for detecting and classifying a defect of a substrate according to the present invention is provided, which comprising: a first channel, including a first illuminating unit adapted to irradiate a light to a transparent or semi-transparent substrate and a first imaging unit adapted to take images by sensing a light from the substrate when the first illuminating unit irradiates the light to the substrate; a second channel, including a second illuminating unit adapted to irradiate a light to the substrate and a second imaging unit adapted to take images by sensing a light from the substrate when the second illuminating unit irradiates the light to the substrate; an image constructing module, adapted to construct two images of the substrate by using the images taken by the first imaging unit and the images taken by the second imaging unit respectively; and an image processing module, adapted to detect, when the substrate has a defect, that the defect is a defect on the substrate or in the substrate, based on a relationship of positions where the defect of the substrate appears in the two images of the substrate.

A system for detecting and classifying a defect of a substrate according to the present invention is provided, which comprising: a first channel, including a first illuminating unit and a first imaging unit, wherein the first illuminating unit is adapted to irradiate a light to a transparent or semi-transparent substrate, and the first imaging unit is arranged outside another opposite surface of one surface of the substrate and is adapted to take images by sensing a light from the substrate when the first illuminating unit irradiates the light to the substrate; a second channel, including a second illuminating unit and a second imaging unit, wherein the second illuminating unit is adapted to irradiate a light to the substrate, and the second imaging unit is arranged outside the another opposite surface of the substrate and is adapted to take images by sensing a light from the substrate when the second illuminating unit irradiates the light to the substrate; a third channel, including a third illuminating unit and a third imaging unit, wherein the third illuminating unit is adapted to irradiate a light to the substrate, and the third imaging unit is arranged outside the another opposite surface of the substrate and is adapted to take images by sensing a light from the substrate when the third illuminating unit irradiates the light to the substrate; an image constructing module, adapted to construct three images of the substrate by using the images taken by the first imaging unit, the images taken by the second imaging unit and the images taken by the third imaging unit respectively; and an image processing module, adapted to detect a defect of the substrate by performing image processing on the three images of the substrate, detect that the defect is a defect on the substrate or in the substrate based on a relationship of positions where the defect appears in the two images of the substrate constructed by the images taken by the first imaging unit and the images taken by the second imaging unit respectively, and classify the defect based on different features that the defect appears on the three images of the substrate and that the defect is a defect on the substrate or in the substrate.

A method for detecting and classifying a defect of a substrate according to the present invention is provided, which comprising: setting a first channel, wherein the first channel includes a first illuminating unit adapted to irradiate a light to a transparent or semi-transparent substrate and a first imaging unit adapted to take images by sensing a light from the substrate when the first illuminating unit irradiates the light to the substrate; setting a second channel, wherein the second channel includes a second illuminating unit adapted to irradiate a light to the substrate and a second imaging unit adapted to take images by sensing a light from the substrate when the second illuminating unit irradiates the light to the substrate; setting an image constructing module, wherein the image constructing module is adapted to construct two images of the substrate by using the images taken by the first imaging unit and the images taken by the second imaging unit respectively; and setting an image processing module, wherein the image processing module is adapted to detect, when the substrate has a detect, that the defect is a defect on the substrate or in the substrate, based on a relationship of positions where the defect of the substrate appears in the two images of the substrate.

A method for detecting and classifying a defect of a substrate according to the present invention is provided, which comprising: setting a first channel, wherein the first channel includes a first illuminating unit and a first imaging unit, wherein the first illuminating unit is adapted to irradiate a light to a transparent or semi-transparent substrate, and the first imaging unit is arranged outside another opposite surface of one surface of the substrate and is adapted to take images by sensing a light from the substrate when the first illuminating unit irradiates the light to the substrate; setting a second channel, wherein the second channel includes a second illuminating unit and a second imaging unit, wherein the second illuminating unit is adapted to irradiate a light to the substrate, and the second imaging unit is arranged outside the another opposite surface of the substrate and is adapted to take images by sensing a light from the substrate when the second illuminating unit irradiates the light to the substrate; setting a third channel, wherein the third channel includes a third illuminating unit and a third imaging unit, wherein the third illuminating unit is adapted to irradiate a light to the substrate, and the third imaging unit is arranged outside the another opposite surface of the substrate and is adapted to take images by sensing a light from the substrate when the third illuminating unit irradiates the light to the substrate; setting an image constructing module, wherein the image constructing module is adapted to construct three images of the substrate by using the images taken by the first imaging unit, the images taken by the second imaging unit and the images taken by the third imaging unit respectively; and setting an image processing module, wherein the image processing module is adapted to detect a defect of the substrate by performing image processing on the three images of the substrate, detect that the defect a defect on the substrate or in the substrate based on a relationship of positions where the defect appears in the two images of the substrate constructed by the images taken by the first imaging unit and the images taken by the second imaging unit respectively, and classify the defect based on different features that the defect appears on the three images of the substrate and that the defect is a defect on the substrate or in the substrate.

### BRIEF DESCRIPTION OF DRAWINGS

These and other features, characteristics and advantages of the present invention will become more apparent by combination of detailed description in conjunction with the drawings. Wherein:

FIGS. 1A-1K are outlined schematic diagrams showing a solution for detecting and classifying a defect of a substrate according to a first embodiment of the present invention;

FIG. 2 is a structured schematic diagram showing a system for detecting and classifying a defect of a substrate according to the first embodiment of the present invention;

FIG. 3 is a schematic diagram showing an operating time sequence of an illuminating unit and an imaging unit according to the first embodiment of the present invention;

FIG. 4 is a schematic diagram showing an operating time sequence of an illuminating unit and an imaging unit according to a modification of the first embodiment of the present invention;

FIGS. 5A-5G and 5′-5L are outlined schematic diagrams showing a solution for detecting and classifying a defect of a substrate according to a second embodiment of the present invention;

FIG. 6 is a structured schematic diagram showing a system for detecting and classifying a defect of a substrate according to the second embodiment of the present invention;

FIG. 7 is a schematic diagram showing an operating time sequence of an illuminating unit and an imaging unit according to the second embodiment of the present invention; and

FIGS. 8A and 8B are structured schematic diagrams showing a system for detecting and classifying a defect of a substrate according to a modification of the second embodiment of the present invention.

### MODES FOR CARRYING OUT THE INVENTION

Below, embodiments of the present invention will be explained in conjunction with the figures.

### First Embodiment

The first embodiment of the present invention provides a technology of detecting and classifying a defect of a substrate.

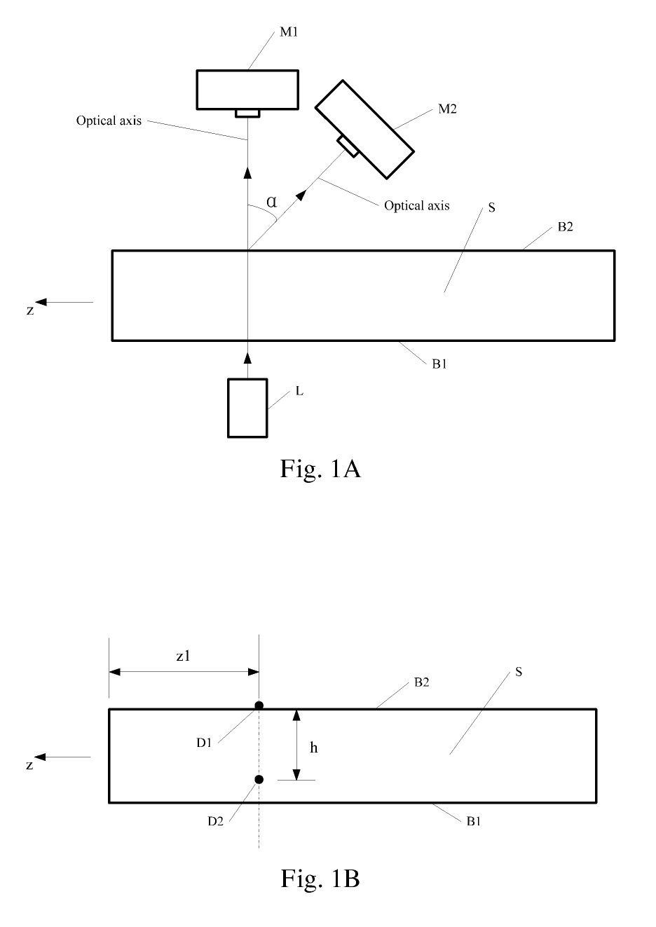

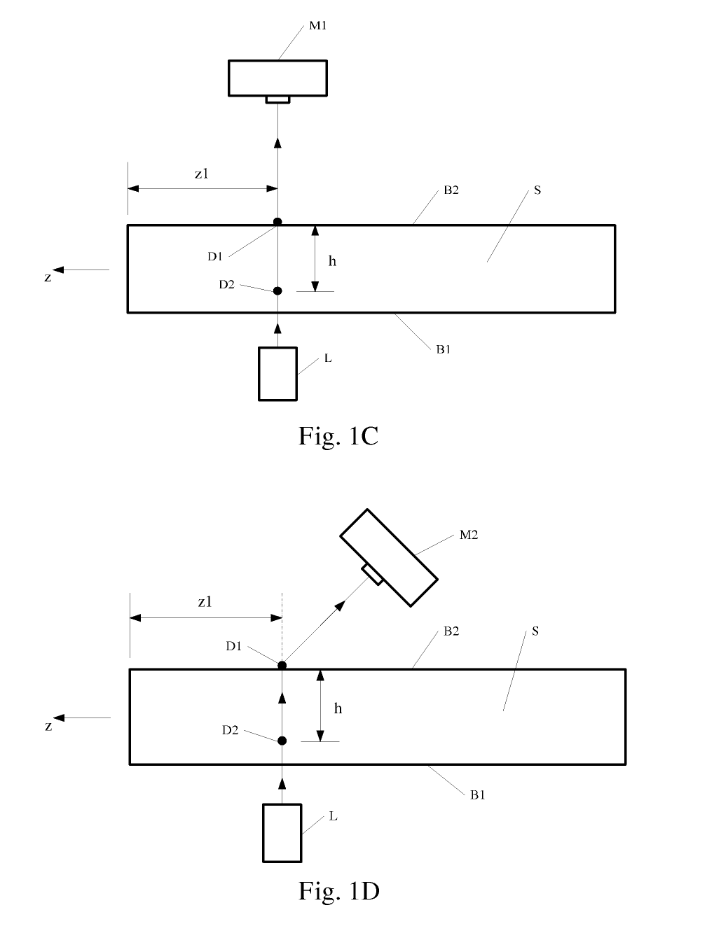

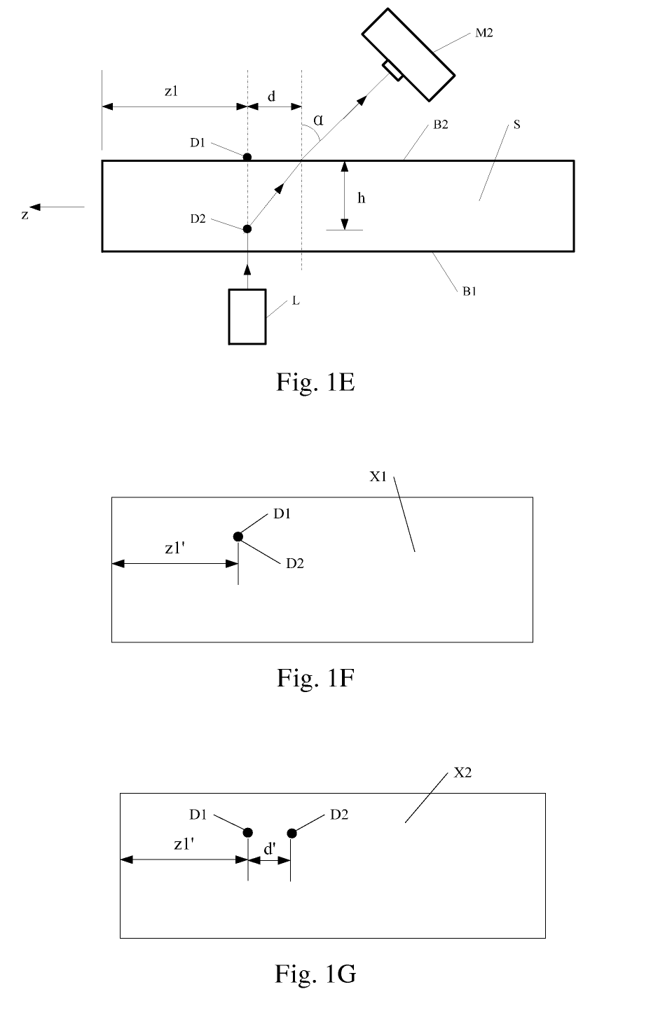

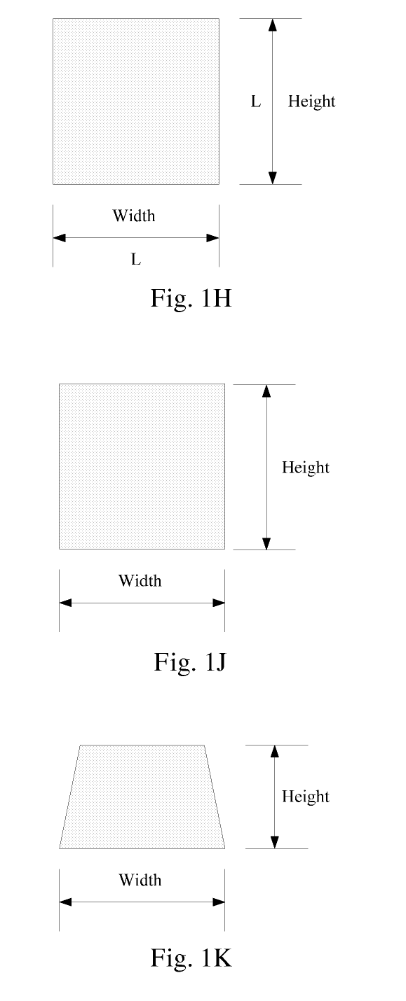

FIGS. 1A-1K are outlined schematic diagrams showing a solution for detecting and classifying a defect of a substrate according to the first embodiment of the present invention.

Firstly, as shown in FIG. 1A, an illuminating unit L is arranged outside one surface B1 of a transparent or semi-transparent substrate S to irradiate a light to the substrate S, and two linear imaging units M1 and M2 are arranged outside another opposite surface B2 of the substrate S to take one-dimension images respectively by sensing the light irradiated to the substrate S by the illuminating unit L and transmitted through the substrate S. An included angle of optical axis of the linear imaging unit M1 and optical axis of the linear imaging unit M2 is α. Here, for convenience of explanation, it is assumed that the optical axis of the linear imaging unit M1 is perpendicular to the surfaces B1 and B2 of the substrate S. When the substrate S moves along the direction z, the linear imaging units M1 and M2 take one-dimension images respectively by sensing continuously at a certain interval the light irradiated to the substrate S by the illuminating unit L and transmitted through the substrate S, and the one-dimension images taken by the linear imaging units M1 are then used to construct the image of the substrate S and the one-dimension images taken by the linear imaging units M2 are also used to construct the image of the substrate S.

As shown in FIG. 1B, it is assumed that the substrate S has two defects D1 and D2 at a position which has an distance z1 with respect to left edge of the substrate S and is vertical to the substrate S, wherein the defect D1 is located on the surface B2 of the substrate S that is at the same side as the linear imaging units M1 and M2, and the defect D2 is located in the substrate S and has a distance h with respect to the surface B2 of the substrate S.

In the process that the linear imaging units M1 and M2 take one-dimension images respectively by sensing continuously at a certain interval the light irradiated to the substrate S by the illuminating unit L and transmitted through the substrate S, when the substrate S moves along the direction z to the position shown in FIG. 1C, the one-dimension image taken by the linear imaging units M1 contains the defects D1 and D2; when the substrate S moves along the direction z to the position shown in FIG. 1D, the one-dimension image taken by the linear imaging units M2 contains the defect D1; and when the substrate S moves along the direction z to the position shown in FIG. 1E, the one-dimension image taken by the linear imaging units M2 contains the defect D2.

The image X1 of the substrate S constructed by using the one-dimension images taken by the linear imaging unit M1 is shown in FIG. 1F, and the image X2 of the substrate S constructed by using the one-dimension images taken by the linear imaging unit M2 is shown in FIG. 1G.

It can be seen by comparing the image X1 of the substrate S shown in FIG. 1F with the image X2 of the substrate S shown in FIG. 1G that: the position where the defect D1 located on the surface B2 of the substrate S appears in the image X1 of the substrate S and the position where the defect D1 located on the surface B2 of the substrate S appears in the image X2 of the substrate S are identical, whereas the position where the defect D2 located in the substrate S appears in the image X1 of the substrate S and the position where the defect D2 located in the substrate S appears in the image X2 of the substrate S are not identical and have an offset d′. The offset d′ is in direct proportion to d shown in FIG. 1E,

$$d = h * tg ( arcsin ( \frac{1}{n} sin α ) )$$

wherein n is refractive index of the substrate S, α is an included angle of optical axis of the linear imaging unit M1 and normal of the surfaces of the substrate S (here refers to the included angle of the optical axis of the linear imaging unit M1 and the optical axis of the linear imaging unit M2). It can be seen that as h and a increase, d increases and the offset d′ also increases. In other words, the larger α is, the more accurate the detection of h is.

In addition, when the distance h that the defect D2 has with respect to the surface B2 of the substrate S is maximal, that is, the defect D2 is located on the another opposite surface B1 of the substrate S, the position where the defect D2 appears in the image X1 and the position where the defect D2 appears in the image X2 are different (not identical) and have an maximal offset.

The above may disclose the following rule: on the condition that there is a certain included angle of the optical axis of the linear imaging unit M1 and the optical axis of the linear imaging unit M2 and the optical axis of the linear imaging unit M1 is perpendicular to the surfaces of the substrate S, in the image X1 of the substrate S constructed by using the one-dimension images taken by the linear imaging unit M1 and the image X2 of the substrate S constructed by using the one-dimension images taken by the linear imaging unit M2, the position where the defect located on the surfaces of the substrate S appears in the image X1 and the position where the defect located on the surfaces of the substrate S appears in the image X2 are identical or have an maximal offset, and the position where the defect located in the substrate S appears in the image X1 and the position where the defect located in the substrate S appears in the image X2 are not identical and the offset between the two positions is less than the offset between the position where the defect located on the surface B1 of the substrate S appears in the image X1 and the position where the defect located on the surface B1 of the substrate S appears in the image X2.

In fact, that the optical axis of the linear imaging unit M1 or M2 is perpendicular to the surfaces of the substrate S is not necessary, and as long as there is a certain included angle of the optical axis of the linear imaging unit M1 and the optical axis of the linear imaging unit M2, in the image X1 of the substrate S constructed by using the one-dimension images taken by the linear imaging unit M1 and the image X2 of the substrate S constructed by using the one-dimension images taken by the linear imaging unit M2, the position where the defect located on the surfaces of the substrate S appears in the image X1 and the position where the defect located on the surfaces of the substrate S appears in the image X2 are identical or have an maximal offset, and the position where the defect located in the substrate S appears in the image X1 and the position where the defect located in the substrate S appears in the image X2 are not identical and the offset between the two positions is less than the offset between the position where the defect located on the surface B1 of the substrate S appears in the image X1 and the position where the defect located on the surface B1 of the substrate S appears in the image X2.

The above rule may be applied to not only the condition that the linear imaging unit is used as an imaging unit but also the condition that a two-dimension imaging unit is used as an imaging unit.

But on the condition that a two-dimension imaging unit is used as an imaging unit, if the two-dimension imaging unit is arranged aslant with respect to the substrate S, that is, a included angle of optical axis of the two-dimension imaging unit and normal of the surfaces of the substrate S is larger than zero, an image taken by the two-dimension imaging unit in this time have a compress deformation with respect to an image taken by the two-dimension imaging unit in the time when a included angle of optical axis of the two-dimension imaging unit and normal of the surfaces of the substrate S is zero. For example, for the square shown in FIG. 1H, when the included angle of optical axis of the two-dimension imaging unit and normal of the surfaces of the substrate S is zero, an image taken by the two-dimension imaging unit is shown in FIG. 1J, and when the included angle of optical axis of the two-dimension imaging unit and normal of the surfaces of the substrate S is larger than zero, an image taken by the two-dimension imaging unit is shown in FIG. 1K. In FIG. 1J, the taken image is a square, whereas in FIG. 1K, the taken image is a trapezoid. It can be seen that, compared to the image shown in FIG. 1J, the bottom side of the image shown in FIG. 1K has no change and its top side and height are compressed. Moreover, as the included angle of optical axis of the two-dimension imaging unit and normal of the surfaces of the substrate S increases, the image taken by the two-dimension imaging unit has larger compress deformation.

Therefore, on the condition that the two-dimension imaging unit is used as the imaging unit, before images taken by the two-dimension imaging unit are used to construct the image of the substrate S, if the included angle of optical axis of the two-dimension imaging unit and normal of the surfaces of the substrate S is larger than zero, the top side and the height of each of the images taken by the two-dimension imaging unit are stretched according to length of the bottom side of each of the images taken by the two-dimension imaging unit, to remove the compress deformation of the images taken by the two-dimension imaging unit.

The method and system for detecting and classifying a defect of the substrate according to the first embodiments of the present invention are made based on the above rule.

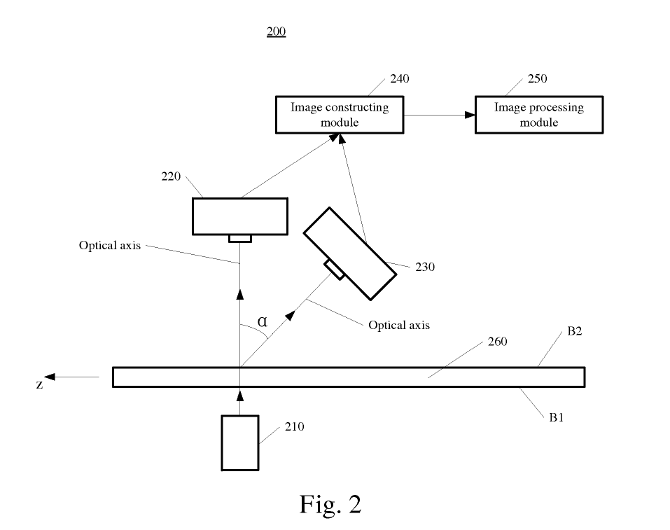

FIG. 2 is a structured schematic diagram showing a system for detecting and classifying a defect of a substrate according to the first embodiment of the present invention. As shown in FIG. 2, the system 200 for differentiating a defect of a substrate may includes an illuminating unit 210, a first imaging unit 220, a second imaging unit 230, an image constructing module 240 and an image processing module 250.

The illuminating unit 210 is arranged outside one surface B1 of a transparent or semi-transparent substrate 260 and adapted to irradiate a light to the substrate 260. The light irradiated to the substrate 260 by the illuminating unit 210 may be a non-diffuse light or a diffuse light. On the condition that the light irradiated to the substrate 260 by the illuminating unit 210 is the diffuse light, if the substrate 260 is a substrate with patterns or structures, influence of the patterns or structures of the substrate 260 on detection of a defect of the substrate 260 can be reduced or even removed. The illuminating unit 210 may include one or more light resources, so that the illuminating unit 210 can irradiate light to the substrate 260 on the range of the whole width of the substrate 260.

The first imaging unit 220 and the second imaging unit 230 are arranged outside another opposite surface B2 of the substrate 260 and adapted to take images respectively by sensing the light irradiated to the substrate 260 by the illuminating unit 210 and transmitted through the substrate 260. An included angle α of the optical axis of the first imaging unit 220 and the optical axis of the second imaging unit 230 is larger than zero. The first imaging unit 220 and the illuminating unit 210 form a first channel and the second imaging unit 230 and the illuminating unit 210 form a second channel, wherein both of the first channel and the second channel belong to bright field illumination. In the process that the system 200 operates, when the substrate 260 moves along the direction z, the first imaging unit 220 and the second imaging unit 230 take images at a predetermined time interval respectively by sensing the light irradiated to the substrate 260 by the illuminating unit 210 and transmitted through the substrate 260.

The first imaging unit 220 and the second imaging unit 230 may be formed by a liner imaging element or an area array imaging element, wherein the linear imaging element may include for example an CCD (Charge Coupled Device) linear imaging element, an CMOS (Complementary Metal Oxide Semiconductor) linear imaging element or other type of linear imaging element, and the area array imaging element may include for example an CCD area array imaging element, an CMOS area array imaging element or other type of area array imaging element. When the first imaging unit 220 and the second imaging unit 230 are linear imaging units, each of the first imaging unit 220 and the second imaging unit 230 may include one or more linear imaging elements set in a line, set staggeredly at two sides of a line, or arranged at an predetermined interval and having a predetermined included angle with respect to a line. When the first imaging unit 220 and the second imaging unit 230 are area array imaging units, each of the first imaging unit 220 and the second imaging unit 230 may include one or more area array imaging elements set in an array, set in a line, set staggeredly at two sides of a line, or arranged at an predetermined interval and having a predetermined included angle with respect to a line.

The image constructing module 240 is connected to the first imaging unit 220 and the second imaging unit 230 and adapted to construct two images of the substrate 260 by using the images taken by the first imaging unit 220 and the images taken by the second imaging unit 230 respectively, that is, construct one image of the substrate 260 by using the images taken by the first imaging unit 220 and another image of the substrate 260 by using the images taken by the second imaging unit 230. For convenience of explanation, the image of the substrate 260 constructed by using the images taken by the first imaging unit 220 is referred to as image T1 and the image of the substrate 260 constructed by using the images taken by the second imaging unit 230 is referred to as image T2.

Wherein, when the first imaging unit 220 and the second imaging unit 230 are two-dimension imaging units, if the images taken by the first imaging unit 220 and/or the second imaging unit 230 have the compress deformation, before the two images of the substrate 260 are constructed by using the images taken by the first imaging unit 220 and the second imaging unit 230, the image constructing module 240 stretches the top side and the height of each of the images taken by the first imaging unit 220 and/or the second imaging unit 230 according to length of the bottom side of each of the images taken by the first imaging unit 220 and/or the second imaging unit 230, to remove the compress deformation of the images taken by the first imaging unit 220 and/or the second imaging unit 230.

The image processing module 250 is connected to the image constructing module 240, and is adapted to process the images T1 and T2 constructed by the image constructing module 240 to determine whether the substrate 260 has a defect, and when it is determined that the substrate 260 has a defect Q, detect whether the defect Q is located on the substrate 260 or in the substrate 260 based on a relationship of the position where the defect Q appears in the image T1 and the position where the defect Q appears in the image T2. Wherein, when the position where the defect Q appears in the image T1 and the position where the defect Q appears in the image T2 are identical or the position where the defect Q appears in the image T1 and the position where the defect Q appears in the image T2 is equal to a maximal offset ZL, the image processing module 250 detects that the defect Q is located on the substrate 260; and when the position where the defect Q appears in the image T1 and the position where the defect Q appears in the image T2 are not identical and the offset between the position where the defect Q appears in the image T1 and the position where the defect Q appears in the image T2 is less than the maximal offset ZL, the image processing module 250 detects that the defect Q is located in the substrate 260.

Here, the image processing module may determine whether the substrate 260 has a defect, by using the solution disclosed in a Chinese patent application No. 200910117993.X filed on Feb. 27, 2009 by the same applicant, or other solutions existing at present and proposed in the future for processing the image to determine whether the substrate has a defect.

The maximal offset ZL is an offset between the position where the defect located on the surface B1 of the substrate 260 appears in the image of the substrate 260 constructed by using the images taken by the first imaging unit 220 and the position where the defect located on the surface B1 of the substrate 260 appears in the image of the substrate 260 constructed by using the images taken by the second imaging unit 230. Here, a calibration board formed by a plurality of equally spaced patterns such as circles and polygons may be arranged on the surface B1 of the substrate 260, and an offset between the position where the same pattern in the calibration board appears in the image of the substrate 260 constructed by using the images taken by the first imaging unit 220 and the position where the same pattern in the calibration board appears in the image of the substrate 260 constructed by using the images taken by the second imaging unit 230 is calculated as the maximal offset ZL. Apparently, those skilled in the art may also use other known technologies to obtain the maximal offset ZL.

The below is an example of detecting, based on the relationship of the positions where the defect Q appears in the images T1 and T2, whether the defect Q is located on the substrate 260 or in the substrate 260. Firstly, the image processing module 250 may calculate coordinates WZ1 of the position where the defect Q appears in the image T1 and coordinates WZ2 of the position where the defect Q appears in the image T2. Secondly, the image processing module 250 may calculate an absolute value JZ of difference of the coordinates WZ1 and WZ2. Thirdly, the image processing module 250 may judge whether the value JZ is equal to zero or the maximal offset ZL. If the judgment result indicates that the value JZ is equal to zero or the maximal offset ZL, the image processing module 250 may detect that the defect Q is a defect located on the substrate 260, and if the judgment result indicates that the value JZ is not equal to zero and the maximal offset ZL, the image processing module 250 may detect that the defect Q is a defect located in the substrate 260.

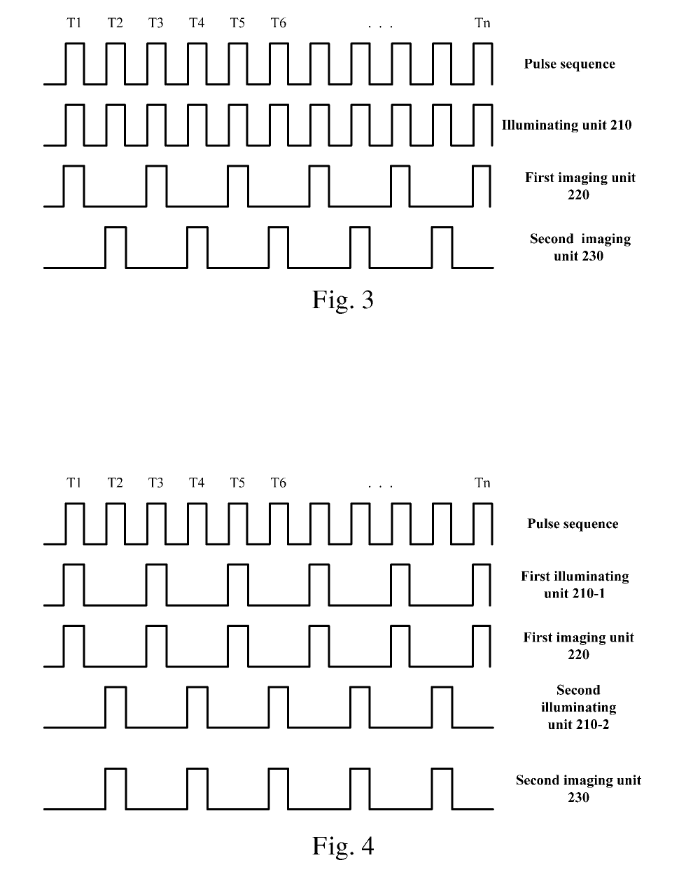

FIG. 3 is a schematic diagram showing an operating time sequence of an illuminating unit and an imaging unit according to an embodiment of the present is invention. As shown in FIG. 3, the illuminating unit 210 irradiates light to the substrate 260 once in every pulse (T1, T2, T3, . . . , Tn), and duration of every irradiating is equal to width of one pulse. The first imaging unit 220 and the second imaging unit 230 take an image respectively at an interval of every two pulses, wherein the time point when the second imaging unit 230 takes an image has a time interval of one pulse width with respect to the time point when the first imaging unit 220 takes an image, that is, the second imaging unit 230 takes an image in pulses with an even number (T2, T4, T6, . . . ) and the first imaging unit 220 takes an image in pulses with an odd number (T1, T3, T5, . . . ).

### Modifications of the First Embodiment

Those skilled in the art will understand that in the above first embodiment, it is the image processing module 250 that processes the images T1 and T2 constructed by the image constructing module 240 to determine whether the substrate 260 has a defect, but the present invention is not so limited. In other some embodiments of the present invention, other module instead of the image processing module 250 may be used to determine whether the substrate 260 has a defect. Under this case, the image processing module 250 is configured to detect, only when it is determined that the substrate 260 has the defect Q, whether the defect Q is located on the substrate 260 or in the substrate 260 based on the relationship of the positions where the defect Q appears in the images T1 and T2.

Those skilled in the art will understand that in the above first embodiment and modification thereof, the illuminating unit 210 irradiates light to the substrate 260 once in every pulse and duration of every irradiating is equal to width of one pulse, but the present invention is not so limited. In other some embodiments of the present invention, the illuminating unit 210 may also irradiates continuously light to the substrate 260 at all times when the system 200 is operating.

Those skilled in the art will understand that in the above first embodiment and modifications thereof, the first imaging unit 220 and the second imaging unit 230 take an image respectively at an interval of every two pulses, but the present invention is not so limited. In other some embodiments of the present invention, the first imaging unit 220 and the second imaging unit 230 take an image respectively at an interval of every one pulse or more than two pulses.

Those skilled in the art will understand that in the above first embodiment and modifications thereof, the time point when the second imaging unit 230 takes an image has a time interval of one pulse width with respect to the time point when the first imaging unit 220 takes an image, but the present invention is not so limited. In other some embodiments of the present invention, the time point when the second imaging unit 230 takes an image may also has an interval of zero or more one pulse width with respect to the time point when the first imaging unit 220 takes an image.

Those skilled in the art will understand that in the above first embodiment and modifications thereof, the first imaging unit 220 and the second imaging unit 230 use the same illuminating unit, i.e., the illuminating unit 210, but the present invention is not so limited. In other some embodiments of the present invention, the illuminating unit 210 may include a first illuminating unit 210-1 and a second illuminating unit 210-2, wherein the first imaging unit 220 takes images by sensing light irradiated to the substrate 260 by the first illuminating unit 210-1 and transmitted through the substrate 260, and the second imaging unit 230 takes images by sensing light irradiated to the substrate 260 by the second illuminating unit 210-2 and transmitted through the substrate 260. FIG. 4 is a schematic diagram showing an operating time sequence of an illuminating unit and an imaging unit according to another embodiment of the present invention. As shown in FIG. 4, the first illuminating unit 210-1 and the second illuminating unit 210-2 irradiate respectively light to the substrate 260 once in every two pulse, and duration of every irradiating is equal to width of one pulse, wherein the time point when the first illuminating unit 210-1 irradiates light to the substrate 260 has a time interval of one pulse width with respect to the time point when the second illuminating unit 210-2 irradiates light to the substrate 260. The first imaging unit 220 takes an image in each of pulses in which the first illuminating unit 210-1 irradiates light to the substrate 260, and the second imaging unit 230 takes an image in each of pulses in which the second illuminating unit 210-2 irradiates light to the substrate 260. Each of the first illuminating unit 210-1 and the second illuminating unit 210-2 may include one or more light resources set in a line or an array.

In addition to the condition shown in FIG. 4, those skilled in the art will understand that the time point when the first illuminating unit 210-1 irradiates light to the substrate 260 and the time point when the second illuminating unit 210-2 irradiates light to the substrate 260 may also be identical, or the time point when the first illuminating unit 210-1 irradiates light to the substrate 260 may also have a time interval of more two pulses with respect to the time point when the second illuminating unit 210-2 irradiates light to the substrate 260.

Those skilled in the art will understand that in the above first embodiment and modification thereof, when the system 200 operates, the substrate 260 moves, whereas the first imaging unit 220, the second imaging unit 230 and the illuminating unit 210 don't move, but the present invention is not so limited. In other some embodiments of the present invention, it is also feasible that the substrate 260 doesn't move and the first imaging unit 220, the second imaging unit 230 and the illuminating unit 210 move when the system 200 operates.

Those skilled in the art will understand that the substrate recited in the above first embodiment and modifications thereof may include a substrate with patterns or structures used in a photovoltaic cell or a photovoltaic module in the solar module industry.

Those skilled in the art will understand that the number of the first imaging unit and the second imaging unit may be determined based on a width of the substrate, an imaging numerical aperture, a detecting precision, and an estimated maximum number and a minimum detecting dimension of a defect of the substrate.

Those skilled in the art will understand that the image constructing module 240 and the image processing module 250 may be implemented by software, hardware and the combination of software and hardware.

Those skilled in the art will understand that in the above first embodiment and modifications thereof, the light from the substrate 260 and received by the first imaging unit 220 and the light from the substrate 260 and received by the second imaging unit 230 are the light irradiated by the illuminating unit 210 and transmitted through the substrate 260 (i.e., bright field illumination), but the present invention is not so limited. In other some embodiments of the present invention, the angle at which the illuminating unit 210 irradiates light to the substrate 260 may be set such that the light from the substrate 260 and received by the first imaging unit 220 and/or the light from the substrate 260 and received by the second imaging unit 230 are the light derived from that the substrate 260 scatters the light irradiated by the illuminating unit 210 (dark field illumination). Specifically, the angle at which the illuminating unit 210 irradiates light to the substrate 260 may be set such that the light from the substrate 260 and received by the first imaging unit 220 and the light from the substrate 260 and received by the second imaging unit 230 are the light derived from that the substrate 260 scatters the light irradiated by the illuminating unit 210; or the angle at which the illuminating unit 210 irradiates light to the substrate 260 may be set such that the light from the substrate 260 and received by the first imaging unit 220 is the light irradiated by the illuminating unit 210 and transmitted through the substrate 260 and the light from the substrate 260 and received by the second imaging unit 230 is the light derived from that the substrate 260 scatters the light irradiated by the illuminating unit 210; or the angle at which the illuminating unit 210 irradiates light to the substrate 260 may be set such that the light from the substrate 260 and received by the first imaging unit 220 is the light derived from that the substrate 260 scatters the light irradiated by the illuminating unit 210 and the light from the substrate 260 and received by the second imaging unit 230 is the light irradiated by the illuminating unit 210 and is transmitted through the substrate 260.

Those skilled in the art will understand that in the above first embodiment and modifications thereof, the first imaging unit 220 and the second imaging unit 230 are arranged outside the surface B2 of the substrate 260, and the illuminating unit 210 is arranged outside the surface B1 of the substrate 260, but the present invention is not so limited. In other some embodiments of the present invention, the illuminating unit 210 may also be arranged outside the surface B2 of the substrate 260 as the first imaging unit 220 and the second imaging unit 230. On condition that the illuminating unit 210 is arranged outside the surface B2 of the substrate 260, the first imaging unit 220 may take images by sensing the light derived from scattering through the substrate 260 of the light irradiated by the illuminating unit 210, and the second imaging unit 230 may take images by sensing the light derived from scattering through the substrate 260 of the light irradiated by the illuminating unit 210.

In addition, on condition that the illuminating 210 includes the first illuminating unit 210-1 and the second illuminating unit 210-2, the angle at which the first illuminating unit 210-1 irradiates light to the substrate 260 and the angle at which the second illuminating unit 210-2 irradiates light to the substrate 260 may be set such that the light from the substrate 260 and received by the first imaging unit 220 is the light derived from that the substrate 260 scatters the light irradiated by the first illuminating unit 210-1 and the light from the substrate 260 and received by the second imaging unit 230 is the light derived from that the substrate 260 scatters the light irradiated by the second illuminating unit 210-2; or the angle at which the first illuminating unit 210-1 irradiates light to the substrate 260 and the angle at which the second illuminating unit 210-2 irradiates light to the substrate 260 may be set such that the light from the substrate 260 and received by the first imaging unit 220 is the light irradiated by the first illuminating unit 210-1 and transmitted through the substrate 260 and the light from the substrate 260 and received by the second imaging unit 230 is the light derived from that the substrate 260 scatters the light irradiated by the second illuminating unit 210-2; or the angle at which the first illuminating unit 210-1 irradiates light to the substrate 260 and the angle at which the second illuminating unit 210-2 irradiates light to the substrate 260 may be set such that the light from the substrate 260 and received by the first imaging unit 220 is the light derived from that the substrate 260 scatters the light irradiated by the first illuminating unit 210-1 and the light from the substrate 260 and received by the second imaging unit 230 is the light irradiated by the second illuminating unit 210-2 and transmitted through the substrate 260. The first illuminating unit 210-1 and the second illuminating unit 210-2 may irradiate light to the substrate 260 alternately or at the same time.

Those skilled in the art will understand that in the above modification, the first illuminating unit 210-1 and the second illuminating unit 210-2 are arranged outside the surface B1 of the substrate 260, but the present invention is not so limited. In other some embodiments of the present invention, the first illuminating unit 210-1 and the second illuminating unit 210-2 may also be arranged outside the surface B2 of the substrate 260 as the first imaging unit 220 and the second imaging unit 230. On condition that the first illuminating unit 210-1 and the second illuminating unit 210-2 are arranged outside the surface B2 of the substrate 260, the first imaging unit 220 may take images by sensing the light derived from scattering through the substrate 260 of the light irradiated by the first illuminating unit 210-1 when the first illuminating unit 210-1 irradiates light to the substrate 260, and the second imaging unit 230 may take images by sensing the light derived from scattering through the substrate 260 of the light irradiated by the second illuminating unit 210-2 when the second illuminating unit 210-2 irradiates light to the substrate 260.

Those skilled in the art will understand that in the above modification, on condition that the illuminating unit 210 includes the first illuminating unit 210-1 and the second illuminating unit 210-2, the first channel includes the first imaging unit 220 and the first illuminating unit 210-1, and the second channel includes the second imaging unit 230 and the second illuminating unit 210-2, but the present invention is not so limited.

In other some embodiments of the present invention, the first channel may further include a first polarization component having a first polarization direction and a second polarization component having a second polarization direction orthogonal to the first polarization direction, wherein the first polarization component is arranged outside the surface B1 of the substrate 260 and is set between the first illuminating unit 210-1 and the substrate 260, the second polarization component is arranged outside the surface B2 of the substrate 260 and is set between the first imaging unit 220 and the substrate 260, the first imaging unit 220 may take images by sensing the light irradiated by the first illuminating unit 210-1 and transmitted through the first polarization component, the substrate 260 and the second polarization component or by sensing the light that is derived from scattering through the substrate 260 of the light irradiated by the first illuminating unit 210-1 and transmitted through the first polarization component and is then transmitted through the second polarization component, and the second imaging unit 230 may take images by sensing the light irradiated by the second illuminating unit 210-2 and transmitted through the substrate 260 or by sensing the light derived from scattering through the substrate 260 of the light irradiated by the second illuminating unit 210-2.

Or, in other some embodiments of the present invention, the second channel may further include a third polarization component having the first polarization direction and a fourth polarization component having the second polarization direction, wherein the third polarization component is arranged outside the surface B1 of the substrate 260 and is set between the second illuminating unit 210-2 and the substrate 260, the fourth polarization component is arranged outside the surface B2 of the substrate 260 and is set between the second imaging unit 230 and the substrate 260, the second imaging unit 230 may take images by sensing the light irradiated by the second illuminating unit 210-2 and transmitted through the third polarization component, the substrate 260 and the fourth polarization component or by sensing the light that is derived from scattering through the substrate 260 of the light irradiated by the second illuminating unit 210-2 and transmitted through the third polarization component and is then transmitted through the fourth polarization component, and the first imaging unit 220 may take images by sensing the light irradiated by the first illuminating unit 210-1 and transmitted through the substrate 260 or by sensing the light derived from scattering through the substrate 260 of the light irradiated by the first illuminating unit 210-1.

Or, in other some embodiments of the present invention, the first channel may further include the first polarization component having the first polarization direction and the second polarization component having the second polarization direction, and the second channel may further include the third polarization component having the first polarization direction and the fourth polarization component having the second polarization direction, wherein the first polarization component is arranged outside the surface B1 of the substrate 260 and is set between the first illuminating unit 210-1 and the substrate 260, the second polarization component is arranged outside the surface B2 of the substrate 260 and is set between the first imaging unit 220 and the substrate 260, the third polarization component is arranged outside the surface B1 of the substrate 260 and is set between the second illuminating unit 210-2 and the substrate 260, the fourth polarization component is arranged outside the surface B2 of the substrate 260 and is set between the second imaging unit 230 and the substrate 260, the first imaging unit 220 may take images by sensing the light irradiated by the first illuminating unit 210-1 and transmitted through the first polarization component, the substrate 260 and the second polarization component or by sensing the light that is derived from scattering through the substrate 260 of the light irradiated by the first illuminating unit 210-1 and transmitted through the first polarization component and is then transmitted through the second polarization component, and the second imaging unit 230 may take images by sensing the light irradiated by the second illuminating unit 210-2 and transmitted through the third polarization component, the substrate 260 and the fourth polarization component or by sensing the light that is derived from scattering through the substrate 260 of the light irradiated by the second illuminating unit 210-2 and transmitted through the third polarization component and is then transmitted through the fourth polarization component.

Those skilled in the art will understand that after it is detected that the defect of the substrate 260 is a defect in the substrate 260 or a defect on the substrate 260, the defect of the substrate 260 may be classified based on different features in which the defect of the substrate 260 appears the images T1 and T2 of the substrate 260 and that the defect of the substrate 260 is a defect in the substrate 260 or a defect on the substrate 260.

For example, it is assumed that the image T1 of the substrate 260 is constructed by using the images taken by sensing the light irradiated by the first illuminating unit 210-1 and transmitted through the substrate 260, the image T2 of the substrate 260 is constructed by using the images taken by sensing the light derived from scattering through the substrate 260 of the light irradiated by the second illuminating unit 210-2, and the angle at which the second illuminating unit 210-2 irradiates light is set such that an open bubble of the substrate 260 is visible in the images taken by the second imaging unit 230; if it is an ellipse that a defect of the substrate 260 appears in the image T1 of the substrate 260 and it is known by comparing the images T1 and T2 that the defect of the substrate 260 is on the substrate 260, the defect of the substrate 260 is classified as an open bubble.

Still for example, it is assumed that the image T1 of the substrate 260 is constructed by the images taken by the first imaging unit 220 by sensing the light irradiated by the first illuminating unit 210-1 and transmitted through the first polarization component, the substrate 260 and the second polarization component, and the image T2 of the substrate 260 is constructed by the images taken by the second imaging unit 230 by sensing the light irradiated by the second illuminating unit 210-2 and transmitted through the third polarization component, the substrate 260 and the fourth polarization component, if a defect of the substrate 260 appears in the images T1 and T2 and it is detected that the defect of the substrate 260 is a defect in the substrate 260, the defect of the substrate 260 is classified as a stress or optical-distortion type defect in the substrate 260 such as an inclusion or a recrystallization.

### Second Embodiment

The second embodiment of the present invention provides a technology of detecting and classifying a defect of a substrate.

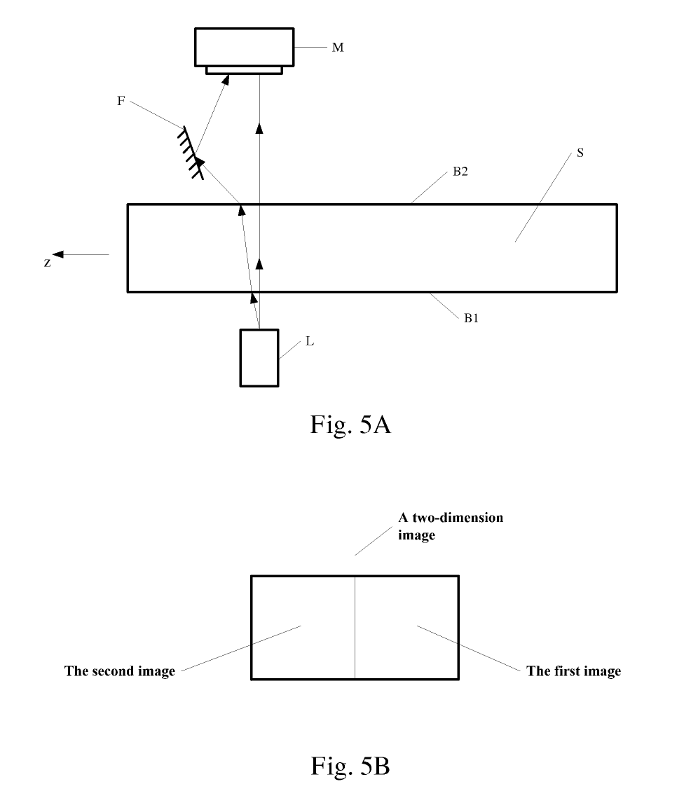

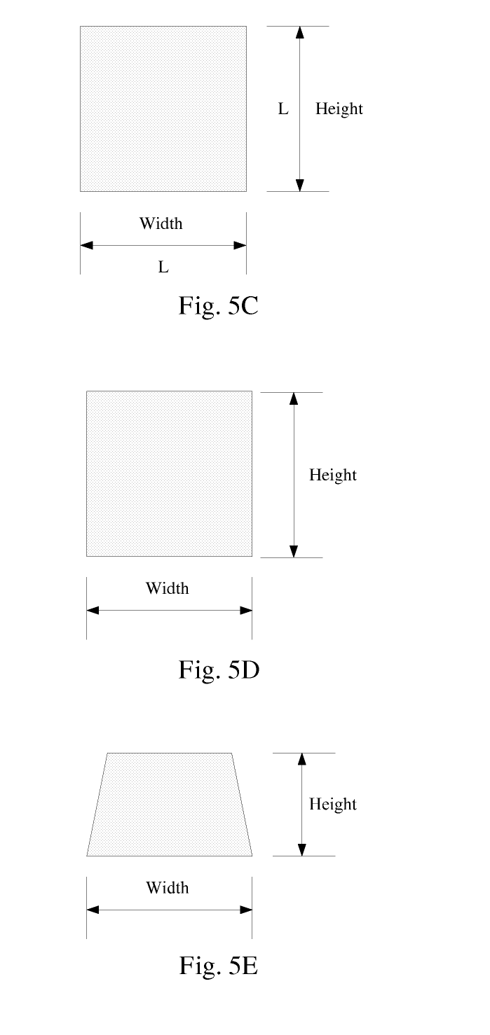

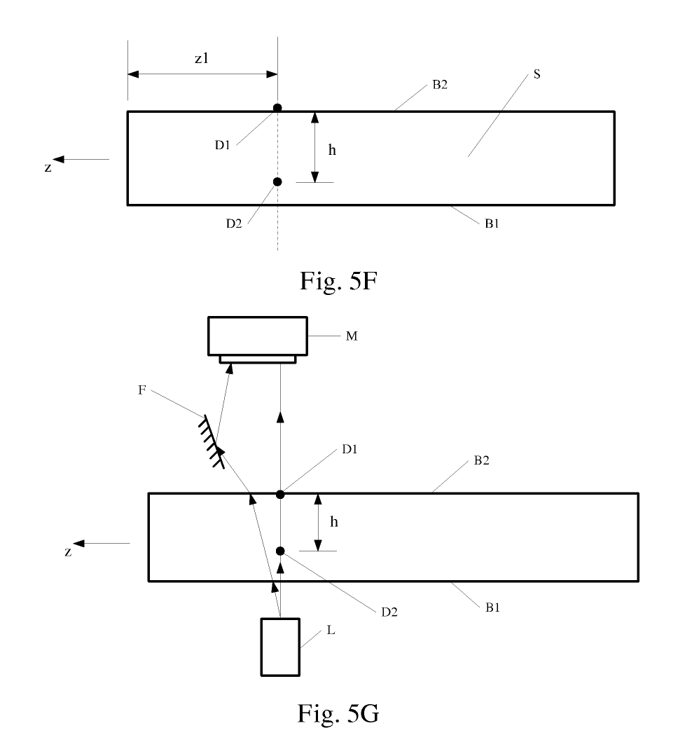

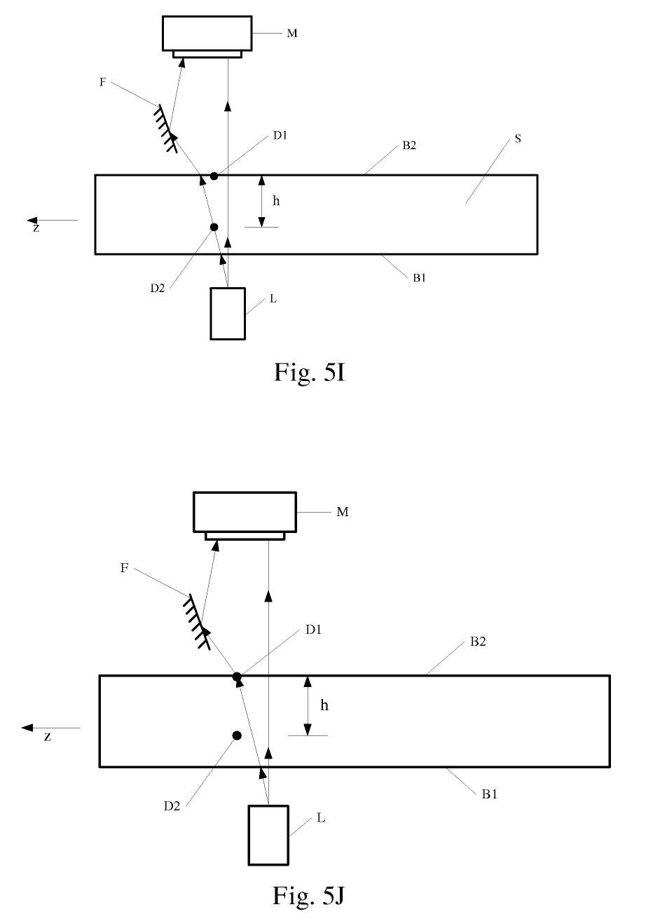

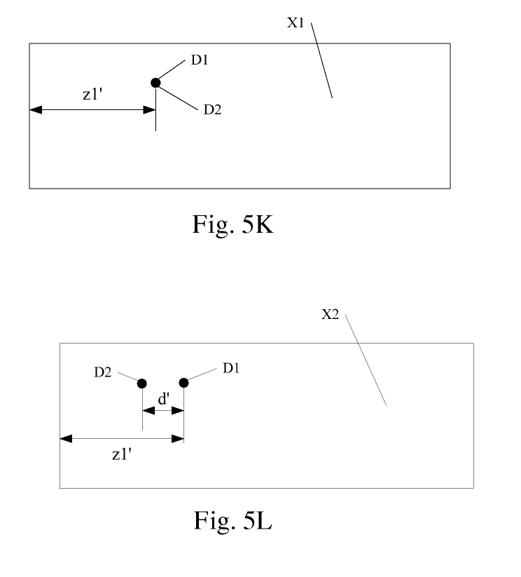

FIGS. 5A-5L are outlined schematic diagrams showing a solution for detecting and classifying a defect of a substrate according to the second embodiment of the present invention.

Firstly, as shown in FIG. 5A, an illuminating unit L is arranged outside one surface B1 of a transparent or semi-transparent substrate S to irradiate a light to the substrate S, and a reflector F and an imaging unit M are arranged outside another opposite surface B2 of the substrate S. The reflector F is adapted to reflect a light irradiated to the substrate S by the illuminating unit L and transmitted through the substrate S into the reflector F, and the imaging unit M, whose optical axis is perpendicular to the surfaces B1 and B2 of the substrate S, is adapted to take a two-dimension image by sensing a light irradiated to the substrate S by the illuminating unit L and transmitted through the substrate S and the light reflected by the reflector F. The two-dimension image taken by the imaging unit M includes a first image taken by sensing the light irradiated to the substrate S by the illuminating unit L and transmitted through the substrate S and a second image taken by sensing the light reflected by the reflector F, the first image and the second image being separated each other, as shown in FIG. 5B.

The light irradiated to the substrate S by the illuminating unit L and transmitted through the substrate S into the reflector F is not perpendicular to the surfaces B1 and B2 of the substrate S, so in the two-dimension image taken by the image unit M, the second image taken by sensing the light reflected by the reflector F has a compression deformation compared with the first image taken by sensing the light irradiated to the substrate S by the illuminating unit L and transmitted through the substrate S. For example, for the square shown in FIG. 5C, in the two-dimension image taken by the image unit M, the first image taken by sensing the light irradiated to the substrate S by the illuminating unit L and transmitted through the substrate S is shown in FIG. 5D, and the second image taken by sensing the light reflected by the reflector F is shown in FIG. 5E. In FIG. 5D, the taken image is still a square, whereas in FIG. 5E, the taken image is a trapezoid. It can be seen that, compared to the image shown in FIG. 5D, the bottom side of the image shown in FIG. 5E has no change and its top side and height are compressed. After the reflector F and the imaging unit M are set with respect to the substrate S, the compression deformation of the second image of the two-dimension image taken by the imaging unit M has been determined. In this time, for example, the compression deformation amount of the second image of the two-dimension image taken by the imaging unit M may be predetermined by placing on the substrate S a calibration board formed by a pattern such as a circle and a polygon and calculating the compression deformation amount of the pattern in the second image of the two-dimension image taken by the imaging unit M.

When the substrate S moves along the direction z, the imaging unit M takes at least one two-dimension image by sensing continuously at a certain interval the light irradiated to the substrate S by the illuminating unit L and transmitted through the substrate S and the light reflected by the reflector F. The second image included in each of the at least one two-dimension image taken by the imaging unit M is stretched according to the predetermined compression deformation amount, to remove the compression deformation of the second image of each of the at least one two-dimension image taken by the imaging unit M. Then, the second image included in the at least one two-dimension image taken by the imaging unit M is used to construct the image of the substrate S and the first image included in the at least one two-dimension image taken by the imaging unit M is also used to construct the image of the substrate S.

As shown in FIG. 5F, it is assumed that the substrate S has two defects D1 and D2 at a position which has an distance z1 with respect to left edge of the substrate S and is vertical to the substrate S, wherein the defect D1 is located on the surface B2 of the substrate S that is at the same side as the imaging unit M, and the defect D2 is located in the substrate S and has a distance h with respect to the surface B2 of the substrate S.

In the process that the imaging unit M take at least one two-dimension image by sensing continuously at a certain interval the light irradiated to the substrate S by the illuminating unit L and transmitted through the substrate S and the light reflected by the reflector F, when the substrate S moves along the direction z to the position shown in FIG. 5G, the first image of the two-dimension image taken by the imaging unit M contains the defects D1 and D2; when the substrate S moves along the direction z to the position shown in FIG. 51, the second image of the two-dimension image taken by the imaging unit M contains the defect D2; and when the substrate S moves along the direction z to the position shown in FIG. 5J, the second image of the two-dimension image taken by the imaging unit M contains the defect D1.

The image X1 of the substrate S constructed by using the first image included in the at least one two-dimension image taken by the imaging unit M is shown in FIG. 5K, and the image X2 of the substrate S constructed by using the stretched second image included in the at least one two-dimension image taken by the imaging unit M is shown in FIG. 5L. It can be seen by comparing the image X1 of the substrate S shown in FIG. 5K with the image X2 of the substrate S shown in FIG. 5L that: the position where the defect D1 located on the surface B2 of the substrate S appears in the image X1 of the substrate S and the position where the defect D1 located on the surface B2 of the substrate S appears in the image X2 of the substrate S are identical, whereas the position where the defect D2 located in the substrate S appears in the image X1 of the substrate S and the position where the defect D2 located in the substrate S appears in the image X2 of the substrate S are not identical and have an offset d′. it is shown by research that the offset d′ increases as h increases. Further, when the distance h between the defect D2 and the surface B2 of the substrate S reaches a maximum, i.e., the defect D2 is located on the surface B1 of the substrate S, the position where the defect D2 appears in the image X1 of the substrate S and the position where the defect D2 appears in the image X2 of the substrate S are not identical and the offset d′ is maximal.

The above may disclose the following rule: for the image X1 of the substrate S constructed by using the first image of the at least one two-dimension image taken by the imaging unit M and the image X2 of the substrate S constructed by using the second image of the at least one two-dimension image taken by the imaging unit M, the position where the defect located on the surface of the substrate S appears in the image X1 of the substrate S and the position where the defect located on the surface of the substrate S appears in the image X2 of the substrate S are identical or the offset between the two positions is maximal, whereas the position where the defect located in the substrate S appears in the image X1 of the substrate S and the position where the defect located in the substrate S appears in the image X2 of the substrate S are not identical and the offset between the two positions is less than the offset between the position where the defect located on the surface B1 of the substrate S appears in the image X1 of the substrate S and the position where the defect located on the surface B1 of the substrate S appears in the image X2 of the substrate S.

The method and system for detecting and classifying a defect of the substrate according to the second embodiment of the present invention are made based on the above rule.

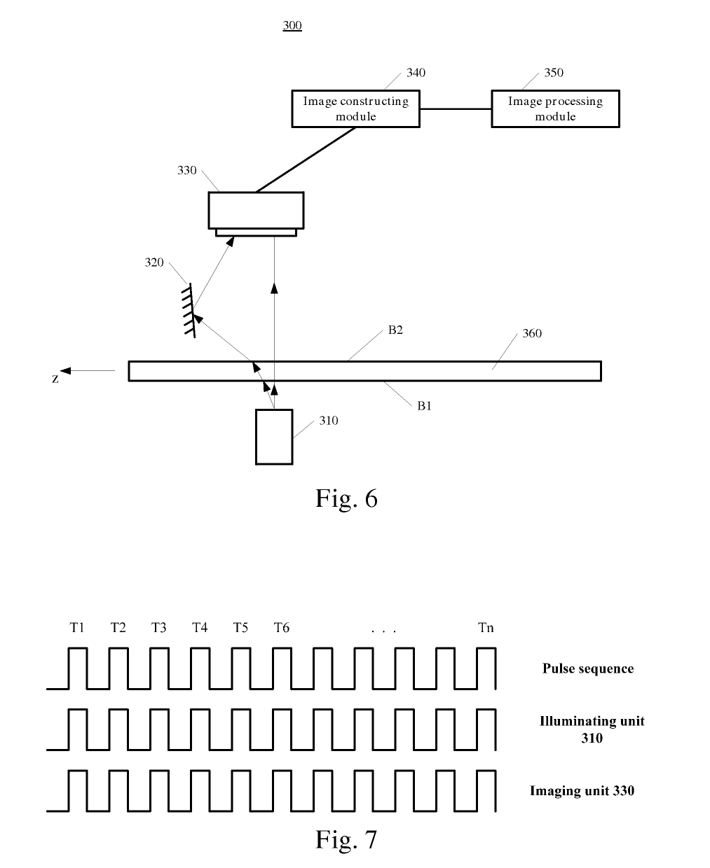

FIG. 6 is a structured schematic diagram showing a system for detecting and classifying a defect of a substrate according to the second embodiment of the present invention. As shown in FIG. 6, the system 300 for differentiating a defect of a substrate may include an illuminating unit 310, a reflector 320, an imaging unit 330, an image constructing module 340 and an image processing module 350.

The illuminating unit 310 is arranged outside a surface B1 of a transparent or semi-transparent substrate 360 and adapted to irradiate a light to the substrate 360. The light irradiated to the substrate 360 by the illuminating unit 310 may be a non-diffuse light or a diffuse light. On the condition that the light irradiated to the substrate 360 by the illuminating unit 310 is the diffuse light, if the substrate 360 is a substrate with patterns or structures, influence of the patterns or structures of the substrate 360 on checking of a defect of the substrate 360 can be reduced or even removed. The illuminating unit 310 may include one or more light resources, so that the illuminating unit 310 can irradiate light to the substrate 360 on the range of the whole width of the substrate 360.

The reflector 320 is arranged outside another opposite surface B2 of the substrate 360 and adapted to reflect a light irradiated to the substrate 360 by the illuminating unit 310 and transmitted through the substrate 360 into the reflector 320.

The imaging unit 330 is arranged outside another opposite surface B2 of the substrate 360 and the optical axis of the imaging unit 330 is perpendicular to the surfaces B1 and B2 of the substrate 360. The imaging unit 330 is adapted to take a two-dimension image by sensing a light irradiated to the substrate 360 by the illuminating unit 310 and transmitted through the substrate 360 and the light reflected by the reflector 320. The two-dimension image taken by the imaging unit 330 includes a first image taken by sensing the light irradiated to the substrate 360 by the illuminating unit 310 and transmitted through the substrate 360 and a second image taken by sensing the light reflected by the reflector 320, the first image and the second image being separated from each other in space. The imaging unit 330 and the illuminating unit 310 may form a third channel, and the reflector 320, the imaging unit 330 and the illuminating unit 310 may form a fourth channel, wherein both of the third channel and the fourth channel belong to the bright field illumination. In the process that the system 300 operates, when the substrate 360 moves along the direction z, the imaging unit 330 takes at least one two-dimension image at a predetermined time interval by sensing the light irradiated to the substrate 360 by the illuminating unit 310 and transmitted through the substrate 360 and the light reflected by the reflector 320.

The imaging unit 330 may be formed by one or more imaging elements. When there is a plurality of imaging elements for forming the imaging unit 330, the plurality of imaging elements are set in an array, set in a line, set staggeredly at two sides of a line, or arranged at a predetermined interval and having a predetermined included angle with respect to a line.

The image constructing module 340 is connected to the imaging unit 330 and adapted to construct two images of the substrate 360 by using respectively the first image and the second image included in the at least one two-dimension image taken by the imaging unit 330, that is, construct one image of the substrate 360 by using the first image included in the at least one two-dimension image taken by the imaging unit 330 and another image of the substrate 360 by using the second image included in the at least one two-dimension image taken by the imaging unit 330. For convenience of explanation, the image of the substrate 360 constructed by using the first image included in the at least one two-dimension image taken by the imaging unit 330 is referred to as image TT1 and the image of the substrate 360 constructed by using the second image included in the at least one two-dimension image taken by the imaging unit 330 is referred to as image TT2.

Wherein, before the image TT2 of the substrate 360 is constructed by using the second image included in each of the at least one two-dimension image taken by the imaging unit 330, the image constructing module 340 stretches the second image included in each of the at least one two-dimension image taken by the imaging unit 330 to remove the compression deformation of the second image included in each of the at least one two-dimension image taken by the imaging unit 330. The compression deformation amount of the second image included in each of the at least one two-dimension image taken by the imaging unit 330 may be predetermined for example by placing on the substrate 360 a calibration board formed by a pattern such as a circle and a polygon and calculating the compression deformation amount of the pattern in the second image included in the two-dimension image taken by the imaging unit 330.

The image processing module 350 is connected to the image constructing module 340, and is adapted to process the images TT1 and TT2 constructed by the image constructing module 340 to determine whether the substrate 360 has a defect, and when it is determined that the substrate 360 has a defect Q, detect whether the defect Q is located on the substrate 360 or in the substrate 360 based on a relationship of the position where the defect Q appears in the image TT1 and the position where the defect Q appears in the image TT2. Wherein, when the position where the defect Q appears in the image TT1 and the position where the defect Q appears in the image TT2 are identical or an offset between the position where the defect Q appears in the image TT1 and the position where the defect Q appears in the image TT2 is equal to a maximal offset ZL, the image processing module 350 detects that the defect Q is located on the substrate 360; and when the position where the defect Q appears in the image TT1 and the position where the defect Q appears in the image TT2 are not identical and the offset between the position where the defect Q appears in the image TT1 and the position where the defect Q appears in the image TT2 is less than the maximal offset ZL, the image processing module 350 detects that the defect Q is located in the substrate 360.

Here, the image processing module 350 may determine whether the substrate 360 has a defect, by using the solution disclosed in a Chinese patent application No. 200910117993.X filed on Feb. 27, 2009 by the same applicant, or other solutions existing at present and proposed in the future for processing the image to determine whether the substrate has a defect.

The maximal offset ZL is an offset between the position where the defect located on the surface B1 of the substrate 360 appears in the image of the substrate 360 constructed by using the first image included in the at least one two-dimension image taken by the imaging unit 330 and the position where the defect located on the surface B1 of the substrate 360 appears in the image of the substrate 360 constructed by using the stretched second image included in the at least one two-dimension image taken by the imaging unit 330. Here, a calibration board formed by a plurality of equally spaced patterns such as circles and polygons may be arranged on the surface B1 of the substrate 360, and an offset between the position where the same pattern in the calibration board appears in the image of the substrate 360 constructed by using the first image of the two-dimension image taken by the imaging unit 330 and the position where the same pattern in the calibration board appears in the image of the substrate 360 constructed by using the stretched second image of the two-dimension image taken by the imaging unit 330 is calculated as the maximal offset ZL. Apparently, those skilled in the art may also use other known technologies to obtain the maximal offset ZL.

The below is an example of detecting, based on the relationship of the positions where the defect Q appears in the images TT1 and TT2, whether the defect Q is located on the substrate 360 or in the substrate 360. Firstly, the image processing module 350 may calculate coordinates WZ1 of the position where the defect Q appears in the image TT1 and coordinates WZ2 of the position where the defect Q appears in the image TT2. Secondly, the image processing module 350 may calculate an absolute value JZ of difference of the coordinates WZ1 and WZ2. Thirdly, the image processing module 350 may judge whether the value JZ is equal to zero or the maximal offset ZL. If the judgment result indicates that the value JZ is equal to zero or the maximal offset ZL, the image processing module 350 may detect that the defect Q is a defect located on the substrate 360, and if the judgment result indicates that the value JZ is not equal to zero and the maximal offset ZL, the image processing module 350 may detect that the defect Q is a defect located in the substrate 360.

FIG. 7 is a schematic diagram showing an operating time sequence of the illuminating unit and the imaging unit according to an embodiment of the present invention. As shown in FIG. 7, the illuminating unit 310 irradiates light to the substrate 360 once in every pulse (T1, T2, T3, . . . , Tn), and duration of every irradiating is equal to width of one pulse. The imaging unit 330 takes a two-dimension image at an interval of every pulse.

It can be seen from the above embodiment that cost is reduced because the images of the two channels are taken by using only one imaging unit; moreover, since the images of the two channels are taken by using only one imaging unit, variations in positions where the defect of the substrate appears in the images of the two channels, which caused by factors for interfering taking of image, are identical, and thus it is more exact that whether the defect of the substrate is located on the surface of the substrate or in the substrate is differentiated by using the taken images.

### Modifications of the Second Embodiment

Those skilled in the art will understand that in the above second embodiment, it is the image processing module 350 that processes the images TT1 and TT2 constructed by the image constructing module 340 to determine whether the substrate 360 has a defect, but the present invention is not so limited. In other some embodiments of the present invention, other module instead of the image processing module 350 may be used to determine whether the substrate 360 has a defect. Under this case, the image processing module 350 is configured to detect, only when it is determined that the substrate 360 has the defect Q, whether the defect Q is located on the substrate 360 or in the substrate 360 based on the relationship of the positions where the defect Q appears in the images TT1 and TT2.

Those skilled in the art will understand that in the above second embodiment and modification thereof, the optical axis of the imaging unit 330 is perpendicular to the surfaces B1 and B2 of the substrate 360, but the present invention is not so limited. In other some embodiments of the present invention, the optical axis of the imaging unit 330 may also be not perpendicular to the surfaces B1 and B2 of the substrate 360. On condition that the optical axis of the imaging unit 330 is not perpendicular to the surfaces B1 and B2 of the substrate 360, in the two-dimension image taken by the imaging unit 330, the first image formed by sensing the light irradiated to the substrate 360 by the illuminating unit 310 and transmitted through the substrate 360 also has the compression deformation, and the compression deformation of the first image may be determined in the same manners as those for the second image; moreover, before the image TT1 of the substrate 360 is constructed by using the first image included in the at least one two-dimension image taken by the imaging unit 330, the image constructing module 340 stretches the first image included in each of the at least one two-dimension image taken by the imaging unit 330 to remove the compression deformation of the first image included in each of the at least one two-dimension image taken by the imaging unit 330.

Those skilled in the art will understand that an interval between the reflector 320 and the substrate 360 may be adjusted according to the practical requirements, so long as the imaging unit 330 can receive the light reflected by the reflector 320, and the light reflected by the reflector 320 and the light irradiated to the substrate 360 by the illuminating unit 310 and transmitted through the substrate 360 can be separated at the imaging unit 330.

Those skilled in the art will understand that in the above second embodiment and modifications thereof, the imaging unit 330 takes a two-dimension image every pulse, but the present invention is not so limited. In other some embodiments of the present invention, the imaging unit 330 takes a two-dimension image every more pulses.

Those skilled in the art will understand that in the above embodiments, the illuminating unit 310 irradiates light to the substrate 360 once in every pulse (T1, T2, T3, . . . , Tn) and duration of every irradiating is equal to width of one pulse, but the present invention is not so limited. In other some embodiments of the present invention, the illuminating unit 310 may also irradiate light to the substrate 360 continuously when the system 300 operates.

Those skilled in the art will understand that in the above second embodiment and modifications thereof, when the system 300 operates, the substrate 360 moves, whereas the reflector 320, the imaging unit 330 and the illuminating unit 310 don't move, but the present invention is not so limited. In other some embodiments of the present invention, it is also feasible that the substrate 360 doesn't move, and the reflector 320, the imaging unit 330 and the illuminating unit 310 move when the system 300 operates.

Those skilled in the art will understand that in the above second embodiment and modifications thereof, the light entering into the reflector 320 is the light irradiated to the substrate 360 by the illuminating unit 310 and transmitted through the substrate 360 (i.e., bright field illumination), and the light from the substrate 360 and received by the imaging unit 330 is the light irradiated to the substrate 360 by the illuminating unit 310 and transmitted through the substrate 360 (i.e., bright field illumination), but the present invention is not so limited. In other some embodiments of the present invention, the light entering into the reflector 320 and/or the light from the substrate 360 and received by the imaging unit 330 may also be the light derived from scattering through the substrate 360 of the light irradiated by the illuminating unit 310 (i.e., dark field illumination). Specifically, the angle at which the illuminating unit 310 irradiates light to the substrate 360 may be set such that the light entering into the reflector 320 and the light from the substrate 360 and received by the imaging unit 330 are the light derived from scattering through the substrate 360 of the light irradiated by the illuminating unit 310; or the angle at which the illuminating unit 310 irradiates light to the substrate 360 may be set such that the light entering into the reflector 320 is the light derived from scattering through the substrate 360 of the light irradiated by the illuminating unit 310 and the light from the substrate 360 and received by the imaging unit 330 is the light irradiated to the substrate 360 by the illuminating unit 310 and transmitted through the substrate 360; or the angle at which the illuminating unit 310 irradiates light to the substrate 360 may be set such that the light entering into the reflector 320 is the light irradiated to the substrate 360 by the illuminating unit 310 and transmitted through the substrate 360 and the light from the substrate 360 and received by the imaging unit 330 is the light derived from scattering through the substrate 360 of the light irradiated by the illuminating unit 310.

Those skilled in the art will understand that in the above second embodiment and modifications thereof, the system 300 includes only one illuminating unit, i.e., the illuminating unit 310, and both of the third channel and the fourth channel include the illuminating unit 310, but the present invention is not so limited. In other some embodiments of the present invention, the illuminating unit 310 may further include a first illuminating unit F1 and a second illuminating unit F2, the third channel may include the first illuminating unit F1 and the imaging unit 330, the fourth channel may include the second illuminating unit F2, the reflector 320 and the imaging unit 330, and the first illuminating unit F1 and the second illuminating unit F2 are arranged outside the surface B1 of the substrate 360 and are adapted to irradiate diffuse light or non-diffuse light to the substrate 360.

On condition that the illuminating unit 310 includes the first illuminating unit F1 and the second illuminating unit F2, the angles at which the first illuminating unit F1 and the second illuminating unit F2 irradiate light to the substrate 360 may be set such that the light entering into the reflector 320 is the light derived from scattering through the substrate 360 of the light irradiated by the second illuminating unit F2 or the light irradiated to the substrate 360 by the second illuminating unit F2 and transmitted through the substrate 360, and the light from the substrate 360 and received by the imaging unit 330 is the light derived from scattering through the substrate 360 of the light irradiated by the first illuminating unit F1 or the light irradiated to the substrate 360 by the first illuminating unit F1 and transmitted through the substrate 360. Specifically, the angles at which the first illuminating unit F1 and the second illuminating unit F2 irradiate light to the substrate 360 is set such that the light entering into the reflector 320 is the light derived from scattering through the substrate 360 of the light irradiated by the second illuminating unit F2, and the light from the substrate 360 and received by the imaging unit 330 is the light irradiated to the substrate 360 by the first illuminating unit F1 and transmitted through the substrate 360; or the angles at which the first illuminating unit F1 and the second illuminating unit F2 irradiate light to the substrate 360 is set such that the light entering into the reflector 320 is the light derived from scattering through the substrate 360 of the light irradiated by the second illuminating unit F2, and the light from the substrate 360 and received by the imaging unit 330 is the light derived from scattering through the substrate 360 of the light irradiated by the first illuminating unit F1; or the angles at which the first illuminating unit F1 and the second illuminating unit F2 irradiate light to the substrate 360 is set such that the light entering into the reflector 320 is the light irradiated to the substrate 360 by the second illuminating unit F2 and transmitted through the substrate 360, and the light from the substrate 360 and received by the imaging unit 330 is the light derived from scattering through the substrate 360 of the light irradiated by the first illuminating unit F1; or the angles at which the first illuminating unit F1 and the second illuminating unit F2 irradiate light to the substrate 360 is set such that the light entering into the reflector 320 is the light irradiated to the substrate 360 by the second illuminating unit F2 and transmitted through the substrate 360, and the light from the substrate 360 and received by the imaging unit 330 is the light irradiated to the substrate 360 by the first illuminating unit F1 and transmitted through the substrate 360. The first illuminating unit F1 and the second illuminating unit F2 may irradiate light to the substrate 360 alternately or at the same time.

Those skilled in the art will understand that in the above modification of the second embodiment, the first illuminating unit F1 and the second illuminating unit F2 included in the illuminating unit 310 are arranged outside the surface B1 of the substrate 360, but the present invention is not so limited. In other some embodiments of the present invention, the first illuminating unit F1 may be arranged outside the surface B1 of the substrate 360 and the second illuminating unit F2 may be arranged outside the surface B2 of the substrate 360.

On condition that the first illuminating unit F1 is arranged outside the surface B1 of the substrate 360 and the second illuminating unit F2 is arranged outside the surface B2 of the substrate 360, the light entering into the reflector 320 is the light derived from scattering through the substrate 360 of the light irradiated by the second illuminating unit F2, and by setting the angle at which the first illuminating unit F1 irradiates light to the substrate 360, the light from the substrate 360 and received by the imaging unit 330 may be the light derived from scattering through the substrate 360 of the light irradiated by the first illuminating unit F1 or the light irradiated to the substrate 360 by the first illuminating unit F1 and transmitted through the substrate 360.

Those skilled in the art will understand that on condition that the first illuminating unit F1 is arranged outside the surface B1 of the substrate 360, in addition to the first illuminating unit F1 and the imaging unit 330, the third channel may further include a first polarization component P1 having a first polarization direction FX1 and a second polarization component P2 having a second polarization direction FX2 orthogonal to the first polarization direction FX1, wherein the first polarization component P1 is arranged outside the surface B1 of the substrate 360 and is arranged between the first illuminating unit F1 and the substrate 360, and the second polarization component P2 is arranged outside the surface B2 of the substrate 360 and is arranged between the substrate 360 and the imaging unit 330, the light from the substrate 360 and received by the imaging unit 330 is the light irradiated to the substrate 360 by the first illuminating unit F1 and transmitted through the first polarization component P1, the substrate 360 and the second polarization component P2 or the light that is derived from scattering through the substrate 360 of the light irradiated by the first illuminating unit F1 and transmitted through the first polarization component P1 and is then transmitted through the second polarization component P2, and the light entering into the reflector 320 may be the light derived from scattering through the substrate 360 of the light irradiated by the second illuminating unit F2 or the light irradiated to the substrate 360 by the second illuminating unit F2 and transmitted through the substrate 360.

Those skilled in the art will understand that on condition that the second illuminating unit F2 is arranged outside the surface B1 of the substrate 360, in addition to the second illuminating unit F2, the reflector 320 and the imaging unit 330, the fourth channel may further include a third polarization component P3 having the first polarization direction FX1 and a fourth polarization component P4 having the second polarization direction FX2, wherein the third polarization component P3 is arranged outside the surface B1 of the substrate 360 and is arranged between the second illuminating unit F2 and the substrate 360, and the fourth polarization component P4 is arranged outside the surface B2 of the substrate 360 and is arranged between the reflector 320 and the imaging unit 330, the light entering into the reflector 320 is the light irradiated by the second illuminating unit F2 and transmitted through the third polarization component P3 and the substrate 360 or the light that is derived from scattering through the substrate 360 of the light irradiated by the second illuminating unit F2 and transmitted through the third polarization component P3, the light from the reflector 320 and received by the imaging unit 330 is the light reflected by the reflector 320 and transmitted through the fourth polarization component P4, and the light from the substrate 360 and received by the imaging unit 330 may be the light derived from scattering through the substrate 360 of the light irradiated by the first illuminating unit F2 or the light irradiated to the substrate 360 by the first illuminating unit F1 and transmitted through the substrate 360.

Those skilled in the art will understand that on condition that the first illuminating unit F1 and the second illuminating unit F2 are arranged outside the surface B1 of the substrate 360, in addition to the first illuminating unit F1 and the imaging unit 330, the third channel may further include the first polarization component P1 having the first polarization direction FX1 and the second polarization component P2 having the second polarization direction FX2, and in addition to the second illuminating unit F2, the reflector 320 and the imaging unit 330, the fourth channel may further include the third polarization component P3 having the first polarization direction FX1 and the fourth polarization component P4 having the second polarization direction FX2. Wherein the first polarization component P1 is arranged outside the surface B1 of the substrate 360 and is arranged between the first illuminating unit F1 and the substrate 360, and the second polarization component P2 is arranged outside the surface B2 of the substrate 360 and is arranged between the substrate 360 and the imaging unit 330, the light from the substrate 360 and received by the imaging unit 330 is the light irradiated to the substrate 360 by the first illuminating unit F1 and transmitted through the first polarization component P1, the substrate 360 and the second polarization component P2 or the light that is derived from scattering through the substrate 360 of the light irradiated by the first illuminating unit F1 and transmitted through the first polarization component P1 and is then transmitted through the second polarization component P2. The third polarization component P3 is arranged outside the surface B1 of the substrate 360 and is arranged between the second illuminating unit F2 and the substrate 360, and the fourth polarization component P4 is arranged outside the surface B2 of the substrate 360 and is arranged between the reflector 320 and the imaging unit 330, the light entering into the reflector 320 is the light irradiated by the second illuminating unit F2 and transmitted through the third polarization component P3 and the substrate 360 or the light that is derived from scattering through the substrate 360 of the light irradiated by the second illuminating unit F2 and transmitted through the third polarization component P3, the light from the reflector 320 and received by the imaging unit 330 is the light reflected by the reflector 320 and transmitted through the fourth polarization component P4.

Those skilled in the art will understand that the first illuminating unit F1 and the second illuminating unit F2 may irradiate diffuse light or non-diffuse light alternately or at the same time.

Those skilled in the art will understand that in the above second embodiment, only one reflector, i.e., the reflector 320, is set in the system 300, the imaging unit 330 is adapted to take a two-dimension image by sensing the light irradiated to the substrate 360 by the illuminating unit 310 and transmitted through the substrate 360 and the light reflected by the reflector 320, and the two-dimension image taken by the imaging unit 330 includes the first image taken by sensing the light irradiated to the substrate 360 by the illuminating unit 310 and transmitted through the substrate 360 and the second image taken by sensing the light reflected by the reflector 320, the first image and the second image being separated from each other in space, but the present invention is not so limited.

In other some embodiments of the present invention, two reflectors, i.e., the reflector 320 and a second reflector SE, are set in the system 300. As the same as the reflector 320, the second reflector SE is arranged outside another opposite surface B2 of the substrate 360 and adapted to reflect a light irradiated to the substrate 360 by the illuminating unit 310 and transmitted through the substrate 360 into the second reflector SE. The imaging unit 330 is adapted to take a two-dimension image by sensing the light reflected by the second reflector SE and the light reflected by the reflector 320, and the two-dimension image taken by the imaging unit 330 includes the first image taken by sensing the light reflected by the second reflector SE and the second image taken by sensing the light reflected by the reflector 320, the first image and the second image being separated from each other in space. The second reflector SE, the imaging unit 330 and the illuminating unit 310 may form the third channel, and the reflector 320, the imaging unit 330 and the illuminating unit 310 may form the fourth channel. As the same as the second image taken by sensing the light reflected by the reflector 320, the first image taken by sensing the light reflected by the second reflector SE also has the compression deformation. Thus, before the image of the substrate 360 is constructed by using the first image taken by sensing the light reflected by the second reflector SE, the first image taken by sensing the light reflected by the second reflector SE need to be stretched to remove the compression deformation of the first image taken by sensing the light reflected by the second reflector SE.

Those skilled in the art will understand that in the above modification of the second embodiment, on condition that the reflector 320 and the second reflector SE are set in the system 300 and the illuminating unit 310 is arranged outside the surface B1 of the substrate 360, the light entering into the reflector 320 and the light entering into the second reflector SE are the light irradiated to the substrate 360 by the illuminating unit 310 and transmitted through the substrate 360 (i.e., bright field illumination), but the present invention is not so limited. In other some embodiments of the present invention, on condition that the reflector 320 and the second reflector SE are set in the system 300 and the illuminating unit 310 is arranged outside the surface B1 of the substrate 360, the light entering into the reflector 320 and/or the light entering into the second reflector SE may also be the light derived from scattering through the substrate 360 of the light irradiated by the illuminating unit 310 (i.e., dark field illumination). Specifically, the angle at which the illuminating unit 310 irradiates light to the substrate 360 is set such that the light entering into the reflector 320 is the light derived from scattering through the substrate 360 of the light irradiated by the illuminating unit 310, and the light entering into the second reflector SE is the light irradiated to the substrate 360 by the illuminating unit 310 and transmitted through the substrate 360; or the angle at which the illuminating unit 310 irradiates light to the substrate 360 is set such that the light entering into the reflector 320 is the light irradiated to the substrate 360 by the illuminating unit 310 and transmitted through the substrate 360, and the light entering into the second reflector SE is the light derived from scattering through the substrate 360 of the light irradiated by the illuminating unit 310; or the angle at which the illuminating unit 310 irradiates light to the substrate 360 is set such that the light entering into the reflector 320 and the light entering into the second reflector SE are the light derived from scattering through the substrate 360 of the light irradiated by the illuminating unit 310.

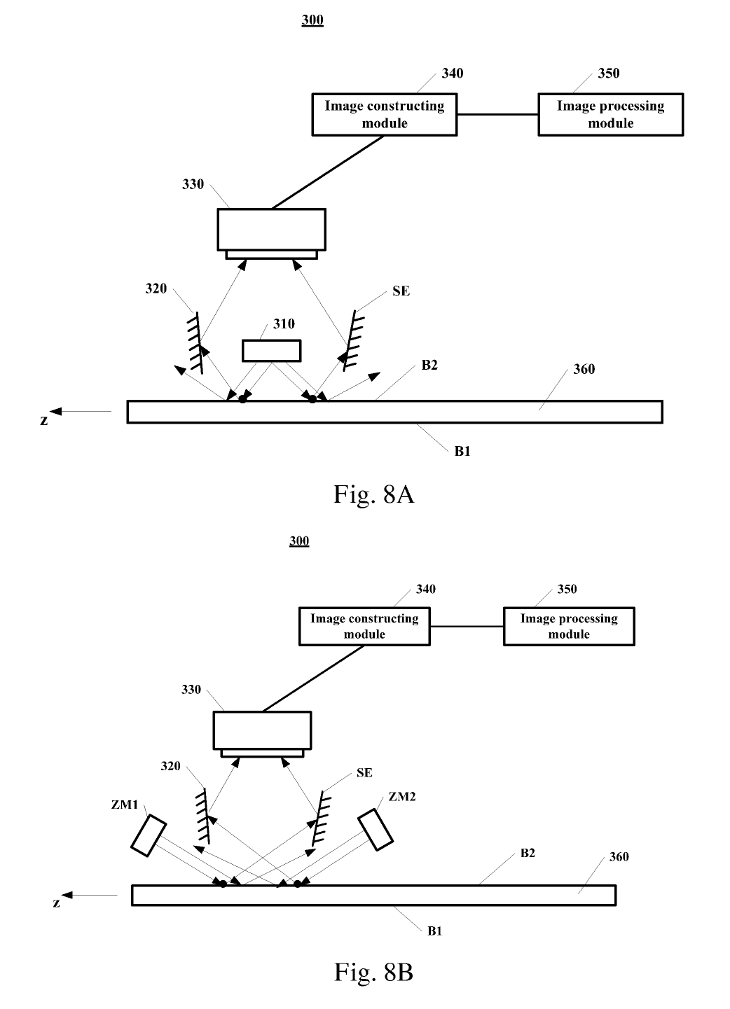

Those skilled in the art will understand that in the above modification of the second embodiment, on condition that the reflector 320 and the second reflector SE are set in the system 300, the illuminating unit 310 is arranged outside the surface B1 of the substrate 360, but the present invention is not so limited. In other some embodiments of the present invention, the illuminating unit 310 may also be arranged outside the surface B2 of the substrate 360 to irradiate diffuse light or non-diffuse light to the substrate 360 (as shown in FIG. 8A). On condition that the illuminating unit 310 is arranged outside the surface B2 of the substrate 360, the light from the substrate 360 and entering into the reflector 320 and the light from the substrate 360 and entering into the second reflector SE are the light derived from scattering through the substrate 360 of the light irradiated by the illuminating unit 310.

Those skilled in the art will understand that in the above modification of the second embodiment, on condition that the reflector 320 and the second reflector SE are set in the system 300, the system 300 includes only one illuminating unit, i.e., the illuminating unit 310, but the present invention is not so limited.

In other some embodiments of the present invention, on condition that the reflector 320 and the second reflector SE are set in the system 300, the system 300 may include a first illuminating unit ZM1 and a second illuminating unit ZM2. Wherein, the first illuminating unit ZM1 and the second illuminating unit ZM2 are arranged outside the surface B1 of the substrate 360 to irradiate diffuse light or non-diffuse light to the substrate 360, the second reflector SE, the imaging unit 330 and the first illuminating unit ZM1 form the third channel, the reflector 320, the imaging unit 330 and the second illuminating unit ZM2 form the fourth channel, the light from the substrate 360 and entering into the reflector 320 may be the light irradiated to the substrate 360 by the second illuminating unit ZM2 and transmitted through the substrate 360 or the light derived from scattering through the substrate 360 of the light irradiated by the second illuminating unit ZM2, and the light from the substrate 360 and entering into the second reflector SE may be the light irradiated to the substrate 360 by the first illuminating unit ZM1 and transmitted through the substrate 360 or the light derived from scattering through the substrate 360 of the light irradiated by the first illuminating unit ZM1. Specifically, the angles at which the first illuminating unit ZM1 and the second illuminating unit ZM2 irradiate light to the substrate 360 may be set such that the light from the substrate 360 and entering into the reflector 320 is the light irradiated to the substrate 360 by the second illuminating unit ZM2 and transmitted through the substrate 360, and the light from the substrate 360 and entering into the second reflector SE is the light irradiated to the substrate 360 by the first illuminating unit ZM1 and transmitted through the substrate 360; or the angles at which the first illuminating unit ZM1 and the second illuminating unit ZM2 irradiate light to the substrate 360 may be set such that the light from the substrate 360 and entering into the reflector 320 is the light irradiated to the substrate 360 by the second illuminating unit ZM2 and transmitted through the substrate 360, and the light from the substrate 360 and entering into the second reflector SE is the light derived from scattering through the substrate 360 of the light irradiated by the first illuminating unit ZM1; or the angles at which the first illuminating unit ZM1 and the second illuminating unit ZM2 irradiate light to the substrate 360 may be set such that the light from the substrate 360 and entering into the reflector 320 is the light derived from scattering through the substrate 360 of the light irradiated by the second illuminating unit ZM2, and the light from the substrate 360 and entering into the second reflector SE is the light irradiated to the substrate 360 by the first illuminating unit ZM1 and transmitted through the substrate 360; or the angles at which the first illuminating unit ZM1 and the second illuminating unit ZM2 irradiate light to the substrate 360 may be set such that the light from the substrate 360 and entering into the reflector 320 is the light derived from scattering through the substrate 360 of the light irradiated by the second illuminating unit ZM2, and the light from the substrate 360 and entering into the second reflector SE is the light derived from scattering through the substrate 360 of the light irradiated by the first illuminating unit ZM1.

Those skilled in the art will understand that on condition that the reflector 320 and the second reflector SE are set in the system 300, in addition to the second is reflector SE, the imaging unit 330 and the first illuminating unit ZM1, the third channel may further include a first polarization component P1 having a first polarization direction FX1 and a second polarization component P2 having a second polarization direction FX2 orthogonal to the first polarization direction FX1, wherein the first polarization component P1 is arranged outside the surface B1 of the substrate 360 and is arranged between the first illuminating unit ZM1 and the substrate 360, and the second polarization component P2 is arranged outside the surface B2 of the substrate 360 and is arranged between the substrate 360 and the imaging unit 330, the light entering into the second reflector SE is the light irradiated to the substrate 360 by the first illuminating unit ZM1 and transmitted through the first polarization component P1 and the substrate 360 or the light that is derived from scattering through the substrate 360 of the light irradiated by the first illuminating unit ZM1 and transmitted through the first polarization component P1, the imaging unit 330 may take the first images by sensing the light reflected by the second reflector SE and transmitted through the second polarization component P2, and the light entering into the reflector 320 may be the light derived from scattering through the substrate 360 of the light irradiated by the second illuminating unit ZM2 or the light irradiated to the substrate 360 by the second illuminating unit ZM2 and transmitted through the substrate 360.

Those skilled in the art will understand that on condition that the reflector 320 and the second reflector SE are set in the system 300, in addition to the second illuminating unit ZM2, the reflector 320 and the imaging unit 330, the fourth channel may further include a third polarization component P3 having the first polarization direction FX1 and a fourth polarization component P4 having the second polarization direction FX2. Wherein, the third polarization component P3 is arranged outside the surface B1 of the substrate 360 and is arranged between the second illuminating unit ZM2 and the substrate 360, and the fourth polarization component P4 is arranged outside the surface B2 of the substrate 360 and is arranged between the reflector 320 and the imaging unit 330, the light entering into the reflector 320 is the light irradiated by the second illuminating unit ZM2 and transmitted through the third polarization component P3 and the substrate 360 or the light that is derived from scattering through the substrate 360 of the light irradiated by the second illuminating unit ZM2 and transmitted through the third polarization component P3, the imaging unit 330 may take the second images by sensing the light reflected by the reflector 320 and transmitted through the fourth polarization component P4, and the light entering into the second reflector SE may be the light derived from scattering through the substrate 360 of the light irradiated by the first illuminating unit ZM1 or the light irradiated to the substrate 360 by the first illuminating unit ZM1 and transmitted through the substrate 360.

Those skilled in the art will understand that on condition that the reflector 320 and the second reflector SE are set in the system 300, in addition to the second reflector SE, the imaging unit 330 and the first illuminating unit ZM1, the third channel may further include the first polarization component P1 having the first polarization direction FX1 and the second polarization component P2 having the second polarization direction FX2, and in addition to the second illuminating unit ZM2, the reflector 320 and the imaging unit 330, the fourth channel may further include the third polarization component P3 having the first polarization direction FX1 and the fourth polarization component P4 having the second polarization direction FX2. Wherein the first polarization component P1 is arranged outside the surface B1 of the substrate 360 and is arranged between the first illuminating unit ZM1 and the substrate 360, and the second polarization component P2 is arranged outside the surface B2 of the substrate 360 and is arranged between the substrate 360 and the imaging unit 330, the light entering into the second reflector SE is the light irradiated to the substrate 360 by the first illuminating unit ZM1 and transmitted through the first polarization component P1, and the substrate 360 or the light that is derived from scattering through the substrate 360 of the light irradiated by the first illuminating unit ZM1 and transmitted through the first polarization component P1, the imaging unit 330 may take the first images by sensing the light reflected by the second reflector SE and transmitted through the second polarization component P2. The third polarization component P3 is arranged outside the surface B1 of the substrate 360 and is arranged between the second illuminating unit ZM2 and the substrate 360, and the fourth polarization component P4 is arranged outside the surface B2 of the substrate 360 and is arranged between the reflector 320 and the imaging unit 330, the light entering into the reflector 320 is the light irradiated by the second illuminating unit ZM2 and transmitted through the third polarization component P3 and the substrate 360 or the light that is derived from scattering through the substrate 360 of the light irradiated by the second illuminating unit ZM2 and transmitted through the third polarization component P3, and the imaging unit 330 may take the second images by sensing the light reflected by the reflector 320 and transmitted through the fourth polarization component P4.

Those skilled in the art will understand that in the above modification of the second embodiment, on condition that the reflector 320 and the second reflector SE are set in the system 300, the first illuminating unit ZM1 and the second illuminating unit ZM2 are arranged outside the surface B1 of the substrate 360, but the present invention is not so limited. In other some embodiments of the present invention, the first illuminating unit ZM1 and the second illuminating unit ZM2 may also be arranged outside the surface B2 of the substrate 360 (as shown in FIG. 8B). On condition that the first illuminating unit ZM1 and the second illuminating unit ZM2 may also be arranged outside the surface B2 of the substrate 360, the light entering into the second reflector SE is the light derived from scattering through the substrate 360 of the light irradiated by the first illuminating unit ZM1, and the light entering into the reflector 320 is the light derived from scattering through the substrate 360 of the light irradiated by the second illuminating unit ZM2.

Those skilled in the art will understand that the first illuminating unit ZM1 and the second illuminating unit ZM2 may irradiate diffuse light or non-diffuse light to the substrate 360 alternately or at the same time.

Those skilled in the art will understand that the substrate recited in the above embodiments may include a substrate with patterns or structures used in a photovoltaic cell or a photovoltaic module in the solar module industry.

Those skilled in the art will understand that the image constructing module 340 and the image processing module 350 may be implemented by software, hardware and the combination of software and hardware.

Those skilled in the art will understand that after it is detected that the defect of the substrate 360 is a defect in the substrate 360 or a defect on the substrate 360, the defect of the substrate 360 may be classified based on different features in which the defect of the substrate 360 appears the images TT1 and TT2 of the substrate 360 and that the defect of the substrate 360 is a defect in the substrate 360 or a defect on the substrate 360.

For example, it is assumed that the light from the substrate 360 and entering into the second reflector SE is the light irradiated to the substrate 360 by the illuminating unit 310 or the first illuminating unit ZM1 and transmitted through the substrate 360, the light from the substrate 360 and entering into the reflector 320 is the light derived from scattering through the substrate 360 of the light irradiated by the illuminating unit 310 or the second illuminating unit ZM2, and the angle at which the illuminating unit 310 or the second illuminating unit ZM2 irradiates to the substrate 360 is set such that an open bubble of the substrate 360 is not visible in the second images taken by the imaging unit 330; if it is an ellipse that a defect of the substrate 360 appears in the image TT1 of the substrate 360 and it is known by comparing the images TT1 and TT2 that the defect of the substrate 360 is on the substrate 360, the defect of the substrate 360 is classified as an open bubble.

Still for example, it is assumed that the light from the substrate 360 and entering into the second reflector SE is the light irradiated by the first illuminating unit ZM1 and transmitted through the first polarization component P1 and the substrate 360, the imaging unit 330 takes the first images by sensing the light reflected by the second reflector SE and transmitted through the second polarization component P2, the light from the substrate 360 and entering into the reflector 320 is the light irradiated by the second illuminating unit ZM2 and transmitted through the third polarization component P3 and the substrate 360, and the imaging unit 330 takes the second images by sensing the light reflected by the reflector 320 and transmitted through the fourth polarization component P4, if a defect of the substrate 360 appears in the images TT1 and TT2 and it is detected that the defect of the substrate 360 is a defect in the substrate 360, the defect of the substrate 360 is classified as a stress or optical-distortion type defect in the substrate 360 such as an inclusion or a recrystallization.

### Third Embodiment

Those skilled in the art will understand that in the above first and second embodiments and modifications thereof, the system for detecting and classifying a defect of a substrate includes only two channels, but the present invention is not so limited.

In a third embodiment of the present invention, the system may further include three channels, i.e., a fifth channel TD1, a sixth channel TD2 and a seventh channel TD3, in addition to the image constructing module GJ and the image processing module CL

The fifth channel TD1 belongs to bright field illumination. The fifth channel TD1 may include a first illuminating unit ZD1 and a first imaging unit CD1, or may include the first illuminating unit ZD1, a first reflector FJ1 and the first imaging unit CD 1.

On condition that the fifth channel TD1 includes the first illuminating unit ZD1 and the first imaging unit CD1, the first illuminating unit ZD1 is arranged outside one surface B1 of a substrate JB and is adapted to irradiate diffuse light or is non-diffuse light to the substrate JB, and the first imaging unit CD1 is arranged outside another opposite surface B2 of the substrate JB and is adapted to take images by sensing light irradiated to the substrate JB by the first illuminating unit ZD1 and transmitted through the substrate JB.

On condition that the fifth channel TD1 includes the first illuminating unit ZD1, the first reflector FJ1 and the first imaging unit CD1, the first illuminating unit ZD1 is arranged outside the one surface B1 of the substrate JB and is adapted to irradiate diffuse light or non-diffuse light to the substrate JB, the first reflector FJ1 is arranged outside the another opposite surface B2 of the substrate JB and is adapted to reflect light irradiated to the substrate JB by the first illuminating unit ZD1, transmitted through the substrate JB and entering into the first reflector FJ1, and the first imaging unit CD1 is arranged outside the another opposite surface B2 of the substrate JB and is adapted to take images by sensing the light reflected by the first reflector FJ1.

The sixth channel TD2 belongs to dark field illumination. The sixth channel TD2 may include a second illuminating unit ZD2 and a second imaging unit CD2, or may include the second illuminating unit ZD2, a second reflector FJ2 and the second imaging unit CD2.

On condition that the sixth channel TD2 includes the second illuminating unit ZD2 and the second imaging unit CD2, the second illuminating unit ZD2 is arranged outside the one surface B1 of a substrate JB and is adapted to irradiate diffuse light or non-diffuse light to the substrate JB, and the second imaging unit CD2 is arranged outside the another opposite surface B2 of the substrate JB and is adapted to take images by sensing light derived from scattering through the substrate JB of the light irradiated by the second illuminating unit ZD2.

On condition that the sixth channel TD2 includes the second illuminating unit ZD2, the second reflector FJ2 and the second imaging unit CD2, the second illuminating unit ZD2 is arranged outside the surface B1 or B2 of the substrate JB and is adapted to irradiate diffuse light or non-diffuse light to the substrate JB, the second reflector FJ2 is arranged outside the another opposite surface B2 of the substrate JB and is adapted to reflect the light that is derived from scattering through the substrate JB of the light irradiated by the second illuminating unit ZD2 and then enters into the second reflector FJ2, and the second imaging unit CD2 is arranged outside the another opposite surface B2 of the substrate JB and is adapted to take images by sensing light reflected by the second reflector FJ2.

The seventh channel TD3 may include a third illuminating unit ZD3, a fifth polarization component PZ5 having a first polarization direction, a sixth polarization component PZ6 having a second polarization direction orthogonal to the first polarization direction and a third imaging unit CD3.

The third illuminating unit ZD3 is arranged outside the one surface B1 of the substrate JB and is adapted to irradiate diffuse light or non-diffuse light to the substrate JB, the fifth polarization component PZ5 is arranged outside the one surface B1 of a substrate JB and between the third illuminating unit ZD3 and the substrate JB, the third imaging unit CD3 is arranged outside the another opposite surface B2 of the substrate JB, the sixth polarization component PZ6 is arranged outside the another opposite surface B2 of the substrate JB and between the third imaging unit CD3 and the substrate JB, and the third imaging unit CD3 is adapted to take images by sensing the light irradiated by the third illuminating unit ZD3 and transmitted through the fifth polarization component PZ5, the substrate JB and the sixth polarization component PZ6 or by sensing the light that is derived from scattering through the substrate JB of the light irradiated by the third illuminating unit ZD3 and transmitted through the fifth polarization component PZ5 and is then transmitted through the sixth polarization component PZ6.

Wherein, the first illuminating unit ZD1, the second illuminating unit ZD2 and the third illuminating unit ZD3 irradiate diffuse light or non-diffuse light to the is substrate JB alternately or at the same time.

The image constructing module GJ is the same operating principle as the image constructing module 240 disclosed in the above first embodiment. Specifically, the image constructing module GJ is connected to the first imaging unit CD1, the second imaging unit CD2 and the third imaging unit CD3 and is adapted to construct three images of the substrate JB by using the images taken by the first imaging unit CD1, the images taken by the second imaging unit CD2 and the images taken by the third imaging unit CD3 respectively. For convenience of explanation, the image of the substrate JB constructed by using the images taken by the first imaging unit CD1 is referred to as image TTT1, the image of the substrate JB constructed by using the images taken by the second imaging unit CD2 is referred to as image TTT2 and the image of the substrate JB constructed by using the images taken by the third imaging unit CD3 is referred to as image TTT3.

Wherein, when the first imaging unit CD1, the second imaging unit CD2 and the third imaging unit CD3 are two-dimension imaging units, if the images taken by the first imaging unit CD1 and/or the second imaging unit CD2 and/or the third imaging unit CD3 have the compress deformation, before the three images of the substrate JB are constructed by using the images taken by the first imaging unit CD1, the second imaging unit CD2 and the third imaging unit CD3, the image constructing module GJ stretches the top side and the height of each of the images taken by the first imaging unit CD1 and/or the second imaging unit CD2 and/or the third imaging unit CD3 according to length of the bottom side of each of the images taken by the first imaging unit CD1 and/or the second imaging unit CD2 and/or the third imaging unit CD3, to remove the compress deformation of the images taken by the first imaging unit CD1 and/or the second imaging unit CD2 and/or the third imaging unit CD3.

The image processing module CJ is the same operating principle as the image is processing module 250 disclosed in the above first embodiment. Specifically, the image processing module CJ is connected to the image constructing module GJ and is adapted to process the images TTT1-TTT3 constructed by the image constructing module GJ to detect a defect Q of the substrate JB, and detect whether the defect Q is located on the substrate JB or in the substrate JB based on a relationship of the positions where the defect Q appears in two images of the images TTT1-TTT3. Wherein, when the positions where the defect Q appears in the two images are identical or an offset between the positions where the defect Q appears in the two images is equal to a maximal offset ZL, the image processing module CL detects that the defect Q is located on the substrate JB; and when the positions where the defect Q appears in the two images are not identical and the offset between the positions where the defect Q appears in the two images is less than the maximal offset ZL, the image processing module CL detects that the defect Q is located in the substrate JB.

After it is detected that the defect Q is a defect in the substrate JB or a defect on the substrate JB, the image processing module may classify the defect Q based on different features in which the defect Q appears in the images TTT1-TTT3 of the substrate JB and that the defect Q is a defect in the substrate JB or a defect on the substrate JB.

For example, it is assumed that the angle at which the second illuminating unit ZD2 irradiates light is set such that an open bubble of the substrate JB is not visible in the images taken by the second illuminating unit CD1, if it is an ellipse that the defect Q appears in the image TTT1 of the substrate JB and the defect Q doesn't appear in the image TTT2 of the substrate JB, the defect Q may be classified as an open bubble.

Still for example, if it is an ellipse that the defect Q appears in the images TTT1 and TTT2 of the substrate JB and the defect Q doesn't appear in the image TTT3 of the substrate JB, and it is detected that the defect Q is a defect in the substrate JB, the defect Q may be classified as non stress or optical-distortion type is defect in the substrate JB.

### Modifications of the Third Embodiment

Those skilled in the art will understand that in the above third embodiment, on condition that the sixth channel TD2 includes the second illuminating unit ZD2, the second reflector FJ2 and the second imaging unit CD2, the second illuminating unit ZD2 is arranged outside the one surface B1 of the substrate JB, but the present invention is not so limited. In other some embodiments of the present invention, on condition that the sixth channel TD2 includes the second illuminating unit ZD2, the second reflector FJ2 and the second imaging unit CD2, the second illuminating unit ZD2 may also be arranged outside the surface B2 of the substrate JB.

Those skilled in the art will understand that in the above third embodiment and modification thereof, the fifth channel TD1, the sixth channel TD2 and the seventh channel TD3 use different illumination modes, but the present invention is not so limited. In other some embodiments of the present invention, the fifth channel TD1 and the sixth channel TD2 may use the same illumination mode and the seventh channel TD3 may use an illumination mode different from those used by the fifth channel TD1 and the sixth channel TD2. The details are given below.

Firstly, the fifth channel TD1 and the sixth channel TD2 use bright field illumination and the seventh channel TD3 uses dark field illumination.

Specifically, the fifth channel TD1 may include the first illuminating unit ZD1 and the first imaging unit CD1, or may include the first illuminating unit ZD1, the first reflector FJ1 and the first imaging unit CD1. On condition that the fifth channel TD1 includes the first illuminating unit ZD1 and the first imaging unit CD1, the first illuminating unit ZD1 is arranged outside the one surface B1 of the is substrate JB and is adapted to irradiate diffuse light or non-diffuse light to the substrate JB, and the first imaging unit CD1 is arranged outside the another opposite surface B2 of the substrate JB and is adapted to take images by sensing light irradiated to the substrate JB by the first illuminating unit ZD1 and transmitted through the substrate JB. On condition that the fifth channel TD1 includes the first illuminating unit ZD1, the first reflector FJ1 and the first imaging unit CD1, the first illuminating unit ZD1 is arranged outside the one surface B1 of the substrate JB and is adapted to irradiate diffuse light or non-diffuse light to the substrate JB, the first reflector FJ1 is arranged outside the another opposite surface B2 of the substrate JB and is adapted to reflect light irradiated to the substrate JB by the first illuminating unit ZD1, transmitted through the substrate JB and entering into the first reflector FJ1, and the first imaging unit CD1 is arranged outside the another opposite surface B2 of the substrate JB and is adapted to take images by sensing the light reflected by the first reflector FJ1.

The sixth channel TD2 may include the second illuminating unit ZD2 and the second imaging unit CD2, or may include the second illuminating unit ZD2, the second reflector FJ2 and the second imaging unit CD2. On condition that the sixth channel TD2 includes the second illuminating unit ZD2 and the second imaging unit CD2, the second illuminating unit ZD2 is arranged outside the one surface B1 of the substrate JB and is adapted to irradiate diffuse light or non-diffuse light to the substrate JB, and the second imaging unit CD2 is arranged outside the another opposite surface B2 of the substrate JB and is adapted to take images by sensing the light irradiated by the second illuminating unit ZD2 and transmitted through the substrate JB. On condition that the sixth channel TD2 includes the second illuminating unit ZD2, the second reflector FJ2 and the second imaging unit CD2, the second illuminating unit ZD2 is arranged outside the one surface B1 of the substrate JB and is adapted to irradiate diffuse light or non-diffuse light to the substrate JB, the second reflector FJ2 is arranged outside the another opposite surface B2 of the substrate JB and is adapted to reflect the light irradiated by the is second illuminating unit ZD2, transmitted through the substrate JB and entering into the second reflector FJ2, and the second imaging unit CD2 is arranged outside the another opposite surface B2 of the substrate JB and is adapted to take images by sensing light reflected by the second reflector FJ2.

The seventh channel TD3 may include the third illuminating unit ZD3 and the third imaging unit CD3, or may include the third illuminating unit ZD3, a third reflector FJ3 and the third imaging unit CD3. On condition that the seventh channel TD3 includes the third illuminating unit ZD3 and the third imaging unit CD3, the third illuminating unit ZD3 is arranged outside the surface B1 or B2 of the substrate JB and is adapted to irradiate diffuse light or non-diffuse light to the substrate JB, and the third imaging unit CD3 is arranged outside the another opposite surface B2 of the substrate JB and is adapted to take images by sensing light derived from scattering through the substrate JB of the light irradiated by the third illuminating unit ZD3. On condition that the seventh channel TD3 includes the third illuminating unit ZD3, the third reflector FJ3 and the third imaging unit CD3, the third illuminating unit ZD3 is arranged outside the surface B1 or B2 of the substrate JB and is adapted to irradiate diffuse light or non-diffuse light to the substrate JB, the third reflector FJ3 is arranged outside the another opposite surface B2 of the substrate JB and is adapted to reflect the light that is derived from scattering through the substrate JB of the light irradiated by the third illuminating unit ZD3 and then enters into the third reflector FJ3, and the third imaging unit CD3 is arranged outside the another opposite surface B2 of the substrate JB and is adapted to take images by sensing light reflected by the third reflector FJ3.

Secondly, the fifth channel TD1 and the sixth channel TD2 use dark field illumination and the seventh channel TD3 uses bright field illumination.

Specifically, the fifth channel TD1 may include the first illuminating unit ZD1 and the first imaging unit CD1, or may include the first illuminating unit ZD1, the first reflector FJ1 and the first imaging unit CD1. On condition that the fifth channel TD1 includes the first illuminating unit ZD1 and the first imaging unit CD1, the first illuminating unit ZD1 is arranged outside the one surface B1 of the substrate JB and is adapted to irradiate diffuse light or non-diffuse light to the substrate JB, and the first imaging unit CD1 is arranged outside the another opposite surface B2 of the substrate JB and is adapted to take images by sensing light derived from scattering through the substrate JB of the light irradiated by the first illuminating unit ZD1. On condition that the fifth channel TD1 includes the first illuminating unit ZD1, the first reflector FJ1 and the first imaging unit CD1, the first illuminating unit ZD1 is arranged outside the surface B1 or B2 of the substrate JB and is adapted to irradiate diffuse light or non-diffuse light to the substrate JB, the first reflector FJ1 is arranged outside the another opposite surface B2 of the substrate JB and is adapted to reflect the light that is derived from scattering through the substrate JB of the light irradiated by the first illuminating unit ZD1 and then enters into the first reflector FJ1, and the first imaging unit CD1 is arranged outside the another opposite surface B2 of the substrate JB and is adapted to take images by sensing light reflected by the first reflector FJ1.

The sixth channel TD2 may include the second illuminating unit ZD2 and the second imaging unit CD2, or may include the second illuminating unit ZD2, the second reflector FJ2 and the second imaging unit CD2. On condition that the sixth channel TD2 includes the second illuminating unit ZD2 and the second imaging unit CD2, the second illuminating unit ZD2 is arranged outside the one surface B1 of the substrate JB and is adapted to irradiate diffuse light or non-diffuse light to the substrate JB, and the second imaging unit CD2 is arranged outside the another opposite surface B2 of the substrate JB and is adapted to take images by sensing light derived from scattering through the substrate JB of the light irradiated by the second illuminating unit ZD2. On condition that the sixth channel TD2 includes the second illuminating unit ZD2, the second reflector FJ2 and the second imaging unit CD2, the second illuminating unit ZD2 is arranged outside the surface B1 or B2 of the substrate JB and is adapted to irradiate diffuse light or non-diffuse light to the substrate JB, the second reflector FJ2 is arranged outside the another opposite surface B2 of the substrate JB and is adapted to reflect the light that is derived from scattering through the substrate JB of the light irradiated by the second illuminating unit ZD2 and then enters into the second reflector FJ2, and the second imaging unit CD2 is arranged outside the another opposite surface B2 of the substrate JB and is adapted to take images by sensing light reflected by the second reflector FJ2.

The seventh channel TD3 may include the third illuminating unit ZD3 and the third imaging unit CD3, or may include the third illuminating unit ZD3, the third reflector FJ3 and the third imaging unit CD3. On condition that the seventh channel TD3 includes the third illuminating unit ZD3 and the third imaging unit CD3, the third illuminating unit ZD3 is arranged outside the one surface B1 of the substrate JB and is adapted to irradiate diffuse light or non-diffuse light to the substrate JB, and the third imaging unit CD3 is arranged outside the another opposite surface B2 of the substrate JB and is adapted to take images by sensing the light irradiated by the third illuminating unit ZD3 and transmitted through the substrate JB. On condition that the seventh channel TD3 includes the third illuminating unit ZD3, the third reflector FJ3 and the third imaging unit CD3, the third illuminating unit ZD3 is arranged outside the one surface B1 of the substrate JB and is adapted to irradiate diffuse light or non-diffuse light to the substrate JB, the third reflector FJ3 is arranged outside the another opposite surface B2 of the substrate JB and is adapted to reflect the light irradiated by the third illuminating unit ZD3, transmitted through the substrate JB and entering into the third reflector FJ3, and the third imaging unit CD3 is arranged outside the another opposite surface B2 of the substrate JB and is adapted to take images by sensing light reflected by the third reflector FJ3.

Thirdly, the fifth channel TD1 and the sixth channel TD2 use bright field illumination and the seventh channel TD3 uses polarization field illumination.

Specifically, the fifth channel TD1 may include the first illuminating unit ZD1 and the first imaging unit CD1, or may include the first illuminating unit ZD1, the first reflector FJ1 and the first imaging unit CD1. On condition that the fifth channel TD1 includes the first illuminating unit ZD1 and the first imaging unit CD1, the first illuminating unit ZD1 is arranged outside one surface B1 of a substrate JB and is adapted to irradiate diffuse light or non-diffuse light to the substrate JB, and the first imaging unit CD1 is arranged outside the another opposite surface B2 of the substrate JB and is adapted to take images by sensing light irradiated to the substrate JB by the first illuminating unit ZD1 and transmitted through the substrate JB. On condition that the fifth channel TD1 includes the first illuminating unit ZD1, the first reflector FJ1 and the first imaging unit CD1, the first illuminating unit ZD1 is arranged outside the one surface B1 of the substrate JB and is adapted to irradiate diffuse light or non-diffuse light to the substrate JB, the first reflector FJ1 is arranged outside the another opposite surface B2 of the substrate JB and is adapted to reflect light irradiated to the substrate JB by the first illuminating unit ZD1, transmitted through the substrate JB and entering into the first reflector FJ1, and the first imaging unit CD1 is arranged outside the another opposite surface B2 of the substrate JB and is adapted to take images by sensing the light reflected by the first reflector FJ1.

The sixth channel TD2 may include the second illuminating unit ZD2 and the second imaging unit CD2, or may include the second illuminating unit ZD2, the second reflector FJ2 and the second imaging unit CD2. On condition that the sixth channel TD2 includes the second illuminating unit ZD2 and the second imaging unit CD2, the second illuminating unit ZD2 is arranged outside the one surface B1 of the substrate JB and is adapted to irradiate diffuse light or non-diffuse light to the substrate JB, and the second imaging unit CD2 is arranged outside the another opposite surface B2 of the substrate JB and is adapted to take images by sensing light derived from scattering through the substrate JB of the light irradiated by the second illuminating unit ZD2. On condition that the sixth channel TD2 includes the second illuminating unit ZD2, the second reflector FJ2 and the second imaging unit CD2, the second illuminating unit ZD2 is arranged outside the one surface B1 of the substrate JB and is adapted to irradiate diffuse light or non-diffuse light to the substrate JB, the second reflector FJ2 is arranged outside the another opposite surface B2 of the substrate JB and is adapted to reflect the light that is derived from scattering through the substrate JB of the light irradiated by the second illuminating unit ZD2 and then enters into the second reflector FJ2, and the second imaging unit CD2 is arranged outside the another opposite surface B2 of the substrate JB and is adapted to take images by sensing light reflected by the second reflector FJ2.

The seventh channel TD3 may include the third illuminating unit ZD3, the fifth polarization component PZ5 having the first polarization direction, the sixth polarization component PZ6 having the second polarization direction orthogonal to the first polarization direction and the third imaging unit CD3. The third illuminating unit ZD3 is arranged outside the one surface B1 of the substrate JB and is adapted to irradiate diffuse light or non-diffuse light to the substrate JB, the fifth polarization component PZ5 is arranged outside the one surface B1 of the substrate JB and between the third illuminating unit ZD3 and the substrate JB, the third imaging unit CD3 is arranged outside the another opposite surface B2 of the substrate JB, the sixth polarization component PZ6 is arranged outside the another opposite surface B2 of the substrate JB and between the third imaging unit CD3 and the substrate JB, and the third imaging unit CD3 is adapted to take images by sensing the light irradiated by the third illuminating unit ZD3 and transmitted through the fifth polarization component PZ5, the substrate JB and the sixth polarization component PZ6 or by sensing the light that is derived from scattering through the substrate JB of the light irradiated by the third illuminating unit ZD3 and transmitted through the fifth polarization component PZ5 and is then transmitted through the sixth polarization component PZ6.

Fourthly, the fifth channel TD1 and the sixth channel TD2 use dark field illumination and the seventh channel TD3 uses polarization field illumination.

Specifically, the fifth channel TD1 may include the first illuminating unit ZD1 and the first imaging unit CD1, or may include the first illuminating unit ZD1, the first reflector FJ1 and the first imaging unit CD1. On condition that the fifth channel TD1 includes the first illuminating unit ZD1 and the first imaging unit CD1, the first illuminating unit ZD1 is arranged outside the one surface B1 of the substrate JB and is adapted to irradiate diffuse light or non-diffuse light to the substrate JB, and the first imaging unit CD1 is arranged outside the another opposite surface B2 of the substrate JB and is adapted to take images by sensing light derived from scattering through the substrate JB of the light irradiated by the first illuminating unit ZD1. On condition that the fifth channel TD1 includes the first illuminating unit ZD1, the first reflector FJ1 and the first imaging unit CD1, the first illuminating unit ZD1 is arranged outside the surface B1 or B2 of the substrate JB and is adapted to irradiate diffuse light or non-diffuse light to the substrate JB, the first reflector FJ1 is arranged outside the another opposite surface B2 of the substrate JB and is adapted to reflect the light that is derived from scattering through the substrate JB of the light irradiated by the first illuminating unit ZD1 and then enters into the first reflector FJ1, and the first imaging unit CD1 is arranged outside the another opposite surface B2 of the substrate JB and is adapted to take images by sensing light reflected by the first reflector FJ1.

The sixth channel TD2 may include the second illuminating unit ZD2 and the second imaging unit CD2, or may include the second illuminating unit ZD2, the second reflector FJ2 and the second imaging unit CD2. On condition that the sixth channel TD2 includes the second illuminating unit ZD2 and the second imaging unit CD2, the second illuminating unit ZD2 is arranged outside the one surface B1 of the substrate JB and is adapted to irradiate diffuse light or non-diffuse light to the substrate JB, and the second imaging unit CD2 is arranged outside the another opposite surface B2 of the substrate JB and is adapted to take images by sensing light derived from scattering through the substrate JB of the light irradiated by the second illuminating unit ZD2. On condition that the sixth channel TD2 includes the second illuminating unit ZD2, the second reflector FJ2 and the second imaging unit CD2, the second illuminating unit ZD2 is arranged outside the surface B1 or B2 of the substrate JB and is adapted to irradiate diffuse light or non-diffuse light to the substrate JB, the second reflector FJ2 is arranged outside the another opposite surface B2 of the substrate JB and is adapted to reflect the light that is derived from scattering through the substrate JB of the light irradiated by the second illuminating unit ZD2 and then enters into the second reflector FJ2, and the second imaging unit CD2 is arranged outside the another opposite surface B2 of the substrate JB and is adapted to take images by sensing light reflected by the second reflector FJ2.

The seventh channel TD3 may include the third illuminating unit ZD3, the fifth polarization component PZ5 having the first polarization direction, the sixth polarization component PZ6 having the second polarization direction orthogonal to the first polarization direction and the third imaging unit CD3. The third illuminating unit ZD3 is arranged outside the one surface B1 of the substrate JB and is adapted to irradiate diffuse light or non-diffuse light to the substrate JB, the fifth polarization component PZ5 is arranged outside the one surface B1 of the substrate JB and between the third illuminating unit ZD3 and the substrate JB, the third imaging unit CD3 is arranged outside the another opposite surface B2 of the substrate JB, the sixth polarization component PZ6 is arranged outside the another opposite surface B2 of the substrate JB and between the third imaging unit CD3 and the substrate JB, and the third imaging unit CD3 is adapted to take images by sensing the light irradiated by the third illuminating unit ZD3 and transmitted through the fifth polarization component PZ5, the substrate JB and the sixth polarization component PZ6 or by sensing the light that is derived from scattering through the substrate JB of the light irradiated by the third illuminating unit ZD3 and transmitted through the fifth polarization component PZ5 and is then transmitted through the sixth polarization component PZ6.

Fifthly, the fifth channel TD1 and the sixth channel TD2 use polarization field illumination and the seventh channel TD3 uses bright field illumination.

Specifically, the fifth channel TD1 may include the first illuminating unit ZD1, the first polarization component PZ1 having the first polarization direction, the second polarization component PZ2 having the second polarization direction orthogonal to the first polarization direction and the first imaging unit CD1. The first illuminating unit ZD1 is arranged outside the one surface B1 of the substrate JB and is adapted to irradiate diffuse light or non-diffuse light to the substrate JB, the first polarization component PZ1 is arranged outside the one surface B1 of the substrate JB and between the first illuminating unit ZD1 and the substrate JB, the first imaging unit CD1 is arranged outside the another opposite surface B2 of the substrate JB, the second polarization component PZ2 is arranged outside the another opposite surface B2 of the substrate JB and between the first imaging unit CD1 and the substrate JB, and the first imaging unit CD1 is adapted to take images by sensing the light irradiated by the first illuminating unit ZD1 and transmitted through the first polarization component PZ1, the substrate JB and the second polarization component PZ2 or by sensing the light that is derived from scattering through the substrate JB of the light irradiated by the first illuminating unit ZD1 and transmitted through the first polarization component PZ1 and is then transmitted through the second polarization component PZ2.

The sixth channel TD2 may include the second illuminating unit ZD2, the third polarization component PZ3 having the first polarization direction, the fourth polarization component PZ4 having the second polarization direction orthogonal to the first polarization direction and the second imaging unit CD2. The second illuminating unit ZD2 is arranged outside the one surface B1 of the substrate JB and is adapted to irradiate diffuse light or non-diffuse light to the substrate JB, the third polarization component PZ3 is arranged outside the one surface B1 of the substrate JB and between the second illuminating unit ZD2 and the substrate JB, the second imaging unit CD2 is arranged outside the another opposite surface B2 of the substrate JB, the fourth polarization component PZ4 is arranged outside the another opposite surface B2 of the substrate JB and between the second imaging unit CD2 and the substrate JB, and the second imaging unit CD2 is adapted to take images by sensing the light irradiated by the second illuminating unit ZD2 and transmitted through the third polarization component PZ3, the substrate JB and the fourth polarization component PZ4 or by sensing the light that is derived from scattering through the substrate JB of the light irradiated by the second illuminating unit ZD2 and transmitted through the third polarization component PZ3 and is then transmitted through the fourth polarization component PZ4.

The seventh channel TD3 may include the third illuminating unit ZD3 and the third imaging unit CD3, or may include the third illuminating unit ZD3, the third reflector FJ3 and the third imaging unit CD3. On condition that the seventh channel TD3 includes the third illuminating unit ZD3 and the third imaging unit CD3, the third illuminating unit ZD3 is arranged outside the one surface B1 of the substrate JB and is adapted to irradiate diffuse light or non-diffuse light to the substrate JB, and the third imaging unit CD3 is arranged outside the another opposite surface B2 of the substrate JB and is adapted to take images by sensing the light irradiated by the third illuminating unit ZD3 and transmitted through the substrate JB. On condition that the seventh channel TD3 includes the third illuminating unit ZD3, the third reflector FJ3 and the third imaging unit CD3, the third illuminating unit ZD3 is arranged outside the one surface B1 of the substrate JB and is adapted to irradiate diffuse light or non-diffuse light to the substrate JB, the third reflector FJ3 is arranged outside the another opposite surface B2 of the substrate JB and is adapted to reflect the light irradiated by the third illuminating unit ZD3, transmitted through the substrate JB and entering into the third reflector FJ3, and the third imaging unit CD3 is arranged outside the another opposite surface B2 of the substrate JB and is adapted to take images by sensing light is reflected by the third reflector FJ3.

Sixthly, the fifth channel TD1 and the sixth channel TD2 use polarization field illumination and the seventh channel TD3 uses dark field illumination.

Specifically, the fifth channel TD1 may include the first illuminating unit ZD1, the first polarization component PZ1 having the first polarization direction, the second polarization component PZ2 having the second polarization direction orthogonal to the first polarization direction and the first imaging unit CD1. The first illuminating unit ZD1 is arranged outside the one surface B1 of the substrate JB and is adapted to irradiate diffuse light or non-diffuse light to the substrate JB, the first polarization component PZ1 is arranged outside the one surface B1 of the substrate JB and between the first illuminating unit ZD1 and the substrate JB, the first imaging unit CD1 is arranged outside the another opposite surface B2 of the substrate JB, the second polarization component PZ2 is arranged outside the another opposite surface B2 of the substrate JB and between the first imaging unit CD1 and the substrate JB, and the first imaging unit CD1 is adapted to take images by sensing the light irradiated by the first illuminating unit ZD1 and transmitted through the first polarization component PZ1, the substrate JB and the second polarization component PZ2 or by sensing the light that is derived from scattering through the substrate JB of the light irradiated by the first illuminating unit ZD1 and transmitted through the first polarization component PZ1 and is then transmitted through the second polarization component PZ2.

The sixth channel TD2 may include the second illuminating unit ZD2, the third polarization component PZ3 having the first polarization direction, the fourth polarization component PZ4 having the second polarization direction orthogonal to the first polarization direction and the second imaging unit CD2. The second illuminating unit ZD2 is arranged outside the one surface B1 of the substrate JB and is adapted to irradiate diffuse light or non-diffuse light to the substrate JB, the third polarization component PZ3 is arranged outside the one surface B1 of the substrate JB and between the second illuminating unit ZD2 and the substrate JB, the second imaging unit CD2 is arranged outside the another opposite surface B2 of the substrate JB, the fourth polarization component PZ4 is arranged outside the another opposite surface B2 of the substrate JB and between the second imaging unit CD2 and the substrate JB, and the second imaging unit CD2 is adapted to take images by sensing the light irradiated by the second illuminating unit ZD2 and transmitted through the third polarization component PZ3, the substrate JB and the fourth polarization component PZ4 or by sensing the light that is derived from scattering through the substrate JB of the light irradiated by the second illuminating unit ZD2 and transmitted through the third polarization component PZ3 and is then transmitted through the fourth polarization component PZ4.

The seventh channel TD3 may include the third illuminating unit ZD3 and the third imaging unit CD3, or may include the third illuminating unit ZD3, a third reflector FJ3 and the third imaging unit CD3. On condition that the seventh channel TD3 includes the third illuminating unit ZD3 and the third imaging unit CD3, the third illuminating unit ZD3 is arranged outside the surface B1 or B2 of the substrate JB and is adapted to irradiate diffuse light or non-diffuse light to the substrate JB, and the third imaging unit CD3 is arranged outside the another opposite surface B2 of the substrate JB and is adapted to take images by sensing light derived from scattering through the substrate JB of the light irradiated by the third illuminating unit ZD3. On condition that the seventh channel TD3 includes the third illuminating unit ZD3, the third reflector FJ3 and the third imaging unit CD3, the third illuminating unit ZD3 is arranged outside the surface B1 or B2 of the substrate JB and is adapted to irradiate diffuse light or non-diffuse light to the substrate JB, the third reflector FJ3 is arranged outside the another opposite surface B2 of the substrate JB and is adapted to reflect the light that is derived from scattering through the substrate JB of the light irradiated by the third illuminating unit ZD3 and then enters into the third reflector FJ3, and the third imaging unit CD3 is arranged outside the another opposite surface B2 of the substrate JB and is adapted to take images by sensing light reflected by the third reflector FJ3.

Those skilled in the art will understand that in the above third embodiment of modifications thereof, the first imaging unit CD1, the second imaging unit CD2 and the third imaging unit CD3 are separated imaging units, but the present invention is not so limited. In other some embodiments of the present invention, the first imaging unit CD1, the second imaging unit CD2 and the third imaging unit CD3 are one and the same imaging unit or the first imaging unit CD1 and the second imaging unit CD2 are one and the same imaging unit. On condition that the first imaging unit CD1, the second imaging unit CD2 and the third imaging unit CD3 are one and the same imaging unit, the images taken by the first imaging unit CD1, the images taken by the second imaging unit CD2 and the images taken by the third imaging unit CD3 are separated each other in the one and the same imaging unit. On condition that the first imaging unit CD1 and the second imaging unit CD2 are one and the same imaging unit, the images taken by the first imaging unit CD1 and the images taken by the second imaging unit CD2 are separated each other in the one and the same imaging unit.

Those skilled in the art will understand that various amendments and modifications on the embodiments of the present invention may be made without being depart from spirits of the invention and the amendments and modifications should fall into the protection scope of the invention. Therefore, the protection scope of the invention will be defined by the claims appended.

1. A system for detecting and classifying a defect of a substrate, comprising:
a first channel, including a first illuminating unit adapted to irradiate a light to a transparent or semi-transparent substrate and a first imaging unit adapted to take images by sensing a light from the substrate when the first illuminating unit irradiates the light to the substrate,
a second channel, including a second illuminating unit adapted to irradiate a light to the substrate and a second imaging unit adapted to take images by sensing a light from the substrate when the second illuminating unit irradiates the light to the substrate,
an image constructing module, adapted to construct two images of the substrate by using the images taken by the first imaging unit and the images taken by the second imaging unit respectively, and
an image processing module, adapted to detect, when the substrate has a defect, that the defect is a defect on the substrate or in the substrate, based on a relationship of positions where the defect of the substrate appears in the two images of the substrate.

2. The system according to claim 1, wherein
the first illuminating unit and the second illuminating unit are arranged outside one surface of the substrate, and
the first imaging unit and the second imaging unit are arranged outside another opposite surface of the substrate, wherein an included angle of optical axes of the first imaging unit and the second imaging unit being greater than zero.

3. The system according to claim 2, wherein
the first imaging unit is adapted to take images by sensing the light irradiated to the substrate by the first illuminating unit and transmitted through the substrate or by sensing the light derived from scattering through the substrate of the light irradiated by the first illuminating unit, the second imaging unit is adapted to take images by sensing the light irradiated to the substrate by the second illuminating unit and transmitted through the substrate or by sensing the light derived from scattering through the substrate of the light irradiated by the second illuminating unit, and
the first illuminating unit and the second illuminating unit are one and the same illuminating unit.

4. The system according to claim 2, wherein
the first channel further includes a first polarization component having a first polarization direction and a second polarization component having a second polarization direction orthogonal to the first polarization direction, wherein the first polarization component is arranged between the first illuminating unit and the substrate, and the second polarization component is arranged between the substrate and the first imaging unit,
the first imaging unit is adapted to take images by sensing the light irradiated by the first illuminating unit and transmitted through the first polarization component, the substrate and the second polarization component or by sensing the light that is derived from scattering through the substrate of the light irradiated by the first illuminating unit and transmitted through the first polarization component and is then transmitted through the second polarization component, and
the second imaging unit is adapted to take images by sensing the light irradiated to the substrate by the second illuminating unit and transmitted through the substrate or by sensing the light derived from scattering through the substrate of the light irradiated by the second illuminating unit.

5. The system according to claim 2, wherein
the first channel further includes a first polarization component having a first polarization direction and a second polarization component having a second polarization direction orthogonal to the first polarization direction, wherein the first polarization component is arranged between the first illuminating unit and the substrate, and the second polarization component is arranged between the substrate and the first imaging unit,
the second channel further includes a third polarization component having the first polarization direction and a fourth polarization component having the second polarization direction, wherein the third polarization component is arranged between the second illuminating unit and the substrate, and the fourth polarization component is arranged between the substrate and the second imaging unit,
the first imaging unit is adapted to take images by sensing the light irradiated by the first illuminating unit and transmitted through the first polarization component, the substrate and the second polarization component or by sensing the light that is derived from scattering through the substrate of the light irradiated by the first illuminating unit and transmitted through the first polarization component and is then transmitted through the second polarization component, and
the second imaging unit is adapted to take images by sensing the light irradiated by the second illuminating unit and transmitted through the third polarization component, the substrate and the fourth polarization component or by sensing the light that is derived from scattering through the substrate of the light irradiated by the second illuminating unit and transmitted through the third polarization component and is then transmitted through the fourth polarization component.

6. The system according to claim 1, wherein
the first channel further includes a first reflector,
the first reflector is arranged outside another opposite surface of one surface of the substrate and is adapted to reflect the light from the substrate and entering into the first reflector,
the first imaging unit and the second imaging unit are arranged outside the another opposite surface of the substrate, the first imaging unit is adapted to take images by sensing the light reflected by the first reflector, and the second imaging unit is adapted to take images by sensing the light from the substrate, and
the first imaging unit and the second imaging unit are one and the same imaging unit, wherein the images taken by the first imaging unit and the images taken by the second imaging unit are separated each other in the one and the same imaging unit,

7. The system according to claim 6, wherein
the first illuminating unit and the second illuminating unit are arranged outside the one surface of the substrate,
the first reflector is adapted to reflect the light irradiated to the substrate by the first illuminating unit, transmitted through the substrate and entering into the first reflector or reflect the light that is derived from scattering through the substrate of the light irradiated by the first illuminating unit and then enters into the first reflector,
the second imaging unit takes images by sensing the light irraditated by the second illuminating unit and transmitted through the substrate or by sensing the light derived from scattering through the substrate of the light irradiated by the second illuminating unit, and the first illuminating unit and the second illuminating unit are one and the same illuminating unit.

8. The system according to claim 6, wherein
the first illuminating unit and the second illuminating unit are arranged outside the one surface of the substrate,
the first channel further includes a first polarization component having a first polarization direction and a second polarization component having a second polarization direction orthogonal to the first polarization direction, wherein the first polarization component is arranged between the first illuminating unit and the substrate, and the second polarization component is arranged between the first reflector and the first imaging unit,
the first reflector is adapted to reflect the light irradiated by the first illuminating unit, transmitted through the first polarization component and the substrate and entering into the first reflector or to reflect the light that is derived from scattering through the substrate of the light irradiated by the first illuminating unit and transmitted through the first polarization component and then enters into the first reflector,
the first imaging unit is adapted to take images by sensing the light reflected by the first reflector and transmitted through the second polarization component, and
the second imaging unit is adapted to take images by sensing the light irradiated to the substrate by the second illuminating unit and transmitted through the substrate or by sensing the light derived from scattering through the substrate of the light irradiated by the second illuminating unit.

9. The system according to claim 6, wherein
the first illuminating unit and the second illuminating unit are arranged outside the one surface of the substrate,
the first channel further includes a first polarization component having a first polarization direction and a second polarization component having a second polarization direction orthogonal to the first polarization direction, wherein the first polarization component is arranged between the first illuminating unit and the substrate, and the second polarization component is arranged between the first reflector and the first imaging unit,
the second channel further includes a third polarization component having the first polarization direction and a fourth polarization component having the second polarization direction, wherein the third polarization component is arranged between the second illuminating unit and the substrate, and the fourth polarization component is arranged between the substrate and the second imaging unit,
the first reflector is adapted to reflect the light irradiated by the first illuminating unit, transmitted through the first polarization component and the substrate and entering into the first reflector or to reflect the light that is derived from scattering through the substrate of the light irradiated by the first illuminating unit and transmitted through the first polarization component and then enters into the first reflector,
the first imaging unit is adapted to take images by sensing the light reflected by the first reflector and transmitted through the second polarization component, and
the second imaging unit is adapted to take images by sensing the light irradiated by the second illuminating unit and transmitted through the third polarization component, the substrate and the fourth polarization component or by sensing the light that is derived from scattering through the substrate of the light irradiated by the second illuminating unit and transmitted through the first polarization component and is then transmitted through the fourth polarization component.

10. The system according to claim 6, wherein
the first illuminating unit is arranged outside the another opposite surface of the substrate, and the second illuminating unit is arranged outside the one surface of the substrate,
the first reflector is adapted to reflect the light that is derived from scattering through the substrate of the light irradiated by the first illuminating unit and then enters into the first reflector, and
the second imaging unit is adapted to take images by sensing the light irradiated to the substrate by the second illuminating unit and transmitted through the substrate or by sensing the light derived from scattering through the substrate of the light irradiated by the second illuminating unit.

11. The system according to claim 6, wherein
the first illuminating unit is arranged outside the another opposite surface of the substrate, and the second illuminating unit is arranged outside the one surface of the substrate,
the second channel further includes a third polarization component having a first polarization direction and a fourth polarization component having a second polarization direction orthogonal to the first polarization direction, wherein the third polarization component is arranged between the second illuminating unit and the substrate, and the fourth polarization component is arranged between the substrate and the second imaging unit,
the first reflector is adapted to reflect the light that is derived from scattering through the substrate of the light irradiated by the first illuminating unit and then enters into the first reflector,
the first imaging unit is adapted to take images by sensing the light reflected by the first reflector, and
the second imaging unit is adapted to take images by sensing the light irradiated by the second illuminating unit and transmitted through the third polarization component, the substrate and the fourth polarization component or by sensing the light that is derived from scattering through the substrate of the light irradiated by the second illuminating unit and transmitted through the first polarization component and is then transmitted through the fourth polarization component.

12. The system according to claim 1, wherein
the first channel further includes a first reflector, wherein the first reflector is arranged outside another opposite surface of one surface of the substrate and is adapted to reflect the light from the substrate and entering into the first reflector,
the second channel further includes a second reflector, wherein the second reflector is arranged outside the another opposite surface of the substrate and is adapted to reflect the light from the substrate and entering into the second reflector,
the first imaging unit and the second imaging unit are arranged the another opposite surface of the substrate, the first imaging unit is adapted to take first images by sensing the light reflected by the first reflector, and the second imaging unit is adapted to take second images by sensing the light reflected by the second reflector, and
the first imaging unit and the second imaging unit are one and the same imaging unit, wherein the first images and the second images are separated each other in the one and the same imaging unit.

13. The system according to claim 12, wherein
the first illuminating unit and the second illuminating unit are arranged outside the one surface of the substrate,
the first reflector is adapted to reflect the light irradiated to the substrate by the first illuminating unit, transmitted through the substrate and entering into the first reflector or to reflect the light that is derived from scattering through the substrate of the light irradiated by the first illuminating unit and then enters into the first reflector, and
the second reflector is adapted to reflect the light irradiated to the substrate by the second illuminating unit, transmitted through the substrate and entering into the second reflector or to reflect the light that is derived from scattering through the substrate of the light irradiated by the second illuminating unit and then enters into the second reflector.

14. The system according to claim 12, wherein
the first illuminating unit and the second illuminating unit are arranged outside the another opposite surface of the substrate,
the first reflector is adapted to reflect the light that is derived from scattering through the substrate of the light irradiated by the first illuminating unit and then enters into the first reflector, and
the second reflector is adapted to reflect the light that is derived from scattering through the substrate of the light irradiated by the second illuminating unit and then enters into the second reflector.

15. The system according to claim 13, wherein
the first illuminating unit and the second illuminating unit are one and the same illuminating unit.

16. The system according to claim 12, wherein
the first illuminating unit and the second illuminating unit are arranged outside the one surface of the substrate,
the first channel further includes a first polarization component having a first polarization direction and a second polarization component having a second polarization direction orthogonal to the first polarization direction, wherein the first polarization component is arranged between the first illuminating unit and the substrate, and the second polarization component is arranged between the first reflector and the one and the same imaging unit,
the first reflector is adapted to reflect the light irradiated by the first illuminating unit, transmitted through the first polarization component and the substrate and entering into the first reflector or to reflect the light that is derived from scattering through the substrate of the light irradiated by the first illuminating unit and transmitted through the first polarization component and then enters into the first reflector,
the one and the same imaging unit is adapted to take the first images by sensing the light reflected by the first reflector and transmitted through the second polarization component, and
the one and the same imaging unit is further adapted to take the second images by sensing the light irradiated to the substrate by the second illuminating unit and transmitted through the substrate or by sensing the light derived from scattering through the substrate of the light irradiated by the second illuminating unit.

17. The system according to claim 12, wherein
the first illuminating unit and the second illuminating unit are arranged outside the one surface of the substrate,
the first channel further includes a first polarization component having a first polarization direction and a second polarization component having a second polarization direction orthogonal to the first polarization direction, wherein the first polarization component is arranged between the first illuminating unit and the substrate, and the second polarization component is arranged between the first reflector and the one and the same imaging unit,
the second channel further includes a third polarization component having the first polarization direction and a fourth polarization component having the second polarization direction, wherein the third polarization component is arranged between the second illuminating unit and the substrate, and the fourth polarization component is arranged between the second reflector and the one and the same imaging unit,
the first reflector is adapted to reflect the light irradiated by the first illuminating unit, transmitted through the first polarization component and the substrate and entering into the first reflector or to reflect the light that is derived from scattering through the substrate of the light irradiated by the first illuminating unit and transmitted through the first polarization component and then enters into the first reflector,
the one and the same imaging unit is adapted to take the first images by sensing the light reflected by the first reflector and transmitted through the second polarization component,
the second reflector is adapted to reflect the light irradiated by the second illuminating unit, transmitted through the third polarization component and the substrate and entering into the second reflector or to reflect the light that is derived from scattering through the substrate of the light irradiated by the second illuminating unit and transmitted through the third polarization component and then enters into the second reflector, and
the one and the same imaging unit is adapted to take the second images by sensing the light reflected by the second reflector and transmitted through the fourth polarization component.

18. The system according to claim 1, wherein
the image processing module is further adapted to detect that the defect is a defect on the substrate, when the positions where the defect appears in the two images are identical or an offset between the positions is equal to a maximum offset, wherein the maximum offset is equal to an offset between positions where a defect located on the one surface of the substrate appears in the two images.

19. The system according to claim 1, wherein
the image processing module is further adapted to detect that the defect is a defect in the substrate, when the positions where the defect appears in the two images are not identical and an offset between the positions is less than a maximum offset, wherein the maximum offset is equal to an offset between positions where a defect located on the one surface of the substrate appears in the two images.

20. The system according to claim 1, wherein
the first imaging unit and the second imaging unit are further adapted to take images by sensing at a predefined time interval the light from the substrate in the same time or at a predetermined time period apart.

21. The system according to claim 1, wherein
each of the first imaging unit and the second imaging unit is a two-dimension imaging unit, and
the image constructing module is further adapted to stretch the images taken by the first imaging unit and/or the second imaging unit when the images taken by the first imaging unit and/or the second imaging unit have a compress deformation, and construct the two images of the substrate by using the images taken by the first imaging unit and the images taken by the second imaging unit respectively, after the images taken by the first imaging unit and/or the second imaging unit are stretched.

22. A system for detecting and classifying a defect of a substrate, comprising:
a first channel, including a first illuminating unit and a first imaging unit, wherein the first illuminating unit is adapted to irradiate a light to a transparent or semi-transparent substrate, and the first imaging unit is arranged outside another opposite surface of one surface of the substrate and is adapted to take images by sensing a light from the substrate when the first illuminating unit irradiates the light to the substrate,
a second channel, including a second illuminating unit and a second imaging unit, wherein the second illuminating unit is adapted to irradiate a light to the substrate, and the second imaging unit is arranged outside the another opposite surface of the substrate and is adapted to take images by sensing a light from the substrate when the second illuminating unit irradiates the light to the substrate,
a third channel, including a third illuminating unit and a third imaging unit, wherein the third illuminating unit is adapted to irradiate a light to the substrate, and the third imaging unit is arranged outside the another opposite surface of the substrate and is adapted to take images by sensing a light from the substrate when the third illuminating unit irradiates the light to the substrate,
an image constructing module, adapted to construct three images of the substrate by using the images taken by the first imaging unit, the images taken by the second imaging unit and the images taken by the third imaging unit respectively, and
an image processing module, adapted to detect a defect of the substrate by performing image processing on the three images of the substrate, detect that the defect is a defect on the substrate or in the substrate based on a relationship of positions where the defect appears in the two images of the substrate constructed by the images taken by the first imaging unit and the images taken by the second imaging unit respectively, and classify the defect based on different features that the defect appears on the three images of the substrate and that the defect is a defect on the substrate or in the substrate.

23. The system according to claim 22, wherein
the first illuminating unit is arranged outside the one surface of the substrate, and the first imaging unit is adapted to take images by sensing the light irradiated by the first illuminating unit and transmitted through the substrate,
the second illuminating unit is arranged outside the one surface of the substrate, and the second imaging unit is adapted to take images by sensing the light irradiated by the second illuminating unit and transmitted through the substrate, and
the third imaging unit is adapted to take images by sensing the light derived from scattering through the substrate of the light irradiated by the third illuminating unit.

24. The system according to claim 23, wherein
the third illuminating unit is arranged outside the one surface of the substrate.

25. The system according to claim 23, wherein
the third channel further includes a third reflector, wherein the third illuminating unit is arranged outside the another opposite surface of the substrate, the third reflector is arranged outside the another opposite surface of the substrate and is adapted to reflect the light that is derived from scattering through the substrate of the light irradiated by the third illuminating unit and then enters into the third reflector, and the third imaging unit is adapted to take the images by sensing the light reflected by the third reflector.

26. The system according to claim 23, wherein
the first channel further includes a first reflector, wherein the first reflector is arranged outside the another opposite surface of the substrate and is adapted to reflect the light irradiated by the third illuminating unit, transmitted through the substrate and entering into the first reflector, and the first imaging unit is adapted to take the images by sensing the light reflected by the first reflector.

27. The system according to claim 22, wherein
the third illuminating unit is arranged outside the one surface of the substrate, and the third imaging unit is adapted to take the images by sensing the light irradiated by the third illuminating unit and transmitted through the substrate,
the first imaging unit is adapted to take the images by sensing the light derived from scattering through the substrate of the light irradiated by the first illuminating unit, and the second imaging unit is adapted to take the images by sensing the light derived from scattering through the substrate of the light irradiated by the second illuminating unit.

28. The system according to claim 27, wherein
the first illuminating unit and the second illuminating unit are arranged outside the one surface of the substrate.

29. The system according to claim 27, wherein
the first illuminating unit is arranged outside the one surface of the substrate, the second channel further includes a second reflector, wherein the second illuminating unit is arranged outside the another opposite surface of the substrate, the second reflector is arranged outside the another opposite surface of the substrate and is adapted to reflect the light that is derived from scattering through the substrate of the light irradiated by the second illuminating unit and then enters into the second reflector, and the second imaging unit is adapted to take images by sensing the light reflected by the second reflector.

30. The system according to claim 27, wherein
the third channel further includes a third reflector, wherein the third reflector is arranged outside the another opposite surface of the substrate and is adapted to reflect the light irradiated by the second illuminating unit, transmitted through the substrate and entering into the third reflector, and the third imaging unit is adapted to take images by sensing the light reflected by the third reflector.

31. The system according to claim 22, wherein
the first illuminating unit is arranged outside the one surface of the substrate, and the first imaging unit is adapted to takes images by sensing the light irradiated by the first illuminating unit and transmitted through the substrate,
the second illuminating unit is arranged outside the one surface of the substrate, and the second imaging unit is adapted to takes images by sensing the light irradiated by the second illuminating unit and transmitted through the substrate, and
the third channel further includes a fifth polarization component having a first polarization direction and a sixth polarization component having a second polarization direction orthogonal to the first polarization direction, wherein the third illuminating unit is arranged outside the one surface of the substrate, the fifth polarization component is arranged between the third illuminating unit and the substrate, the sixth polarization component is arranged between the substrate and the third imaging unit, and the third imaging unit is adapted to take the images by sensing the light irradiated by the third illuminating unit and transmitted through the fifth polarization component, the substrate and the sixth polarization component or by sensing the light that is derived from scattering through the substrate of the light irradiated by the third illuminating unit and transmitted through the fifth polarization component and is then transmitted through the sixth polarization component.

32. The system according to claim 31, wherein
the first channel further includes a first reflector, wherein the first reflector is arranged outside the another opposite surface of the substrate and is adapted to reflect the light irradiated by the first illuminating unit, transmitted through the substrate and entering into the first reflector, and the first imaging unit is adapted to take images by sensing the light reflected by the first reflector.

33. The system according to claim 22, wherein
the third channel further includes a fifth polarization component having a first polarization direction and a sixth polarization component having a second polarization direction orthogonal to the first polarization direction, wherein the third illuminating unit is arranged outside the one surface of the substrate, the fifth polarization component is arranged between the third illuminating unit and the substrate, the sixth polarization component is arranged between the substrate and the third imaging unit, and the third imaging unit is adapted to take the images by sensing the light irradiated by the third illuminating unit and transmitted through the fifth polarization component, the substrate and the sixth polarization component or by sensing the light that is derived from scattering through the substrate of the light irradiated by the third illuminating unit and transmitted through the fifth polarization component and is then transmitted through the sixth polarization component,
the first imaging unit is adapted to take the images by sensing the light derived from scattering through the substrate of the light irradiated by the first illuminating unit, and the second imaging unit is adapted to take the images by sensing the light derived from scattering through the substrate of the light irradiated by the second illuminating unit.

34. The system according to claim 33, wherein
the first illuminating unit and the second illuminating unit are arranged outside the one surface of the substrate.

35. The system according to claim 33, wherein
the first illuminating unit is arranged outside the one surface of the substrate, and
the second channel further includes a second reflector, wherein the second illuminating unit is arranged outside the another opposite surface of the substrate, the second reflector is arranged outside the another opposite surface of the substrate and is adapted to reflect the light that is derived from scattering through the substrate of the light irradiated by the second illuminating unit and then enters into the second reflector, and the second imaging unit is adapted to take images by sensing the light reflected by the second reflector.

36. The system according to claim 22, wherein
the first channel farther includes a first polarization component having a first polarization direction and a second polarization component having a second polarization direction orthogonal to the first polarization direction, wherein the first illuminating unit is arranged outside the one surface of the substrate, the first polarization component is arranged between the first illuminating unit and the substrate, the second polarization component is arranged between the substrate and the first imaging unit, and the first imaging unit is adapted to take the images by sensing the light irradiated by the first illuminating unit and transmitted through the first polarization component, the substrate and the second polarization component or by sensing the light that is derived from scattering through the substrate of the light irradiated by the first illuminating unit and transmitted through the first polarization component and is then transmitted through the second polarization component, and
the second channel further includes a third polarization component having the first polarization direction and a fourth polarization component having the second polarization direction, wherein the second illuminating unit is arranged outside the one surface of the substrate, the third polarization component is arranged between the second illuminating unit and the substrate, the fourth polarization component is arranged between the substrate and the second imaging unit, and the second imaging unit is adapted to take the images by sensing the light irradiated by the second illuminating unit and transmitted through the third polarization component, the substrate and the fourth polarization component or by sensing the light that is derived from scattering through the substrate of the light irradiated by the second illuminating unit and transmitted through the third polarization component and is then transmitted through the fourth polarization component.

37. The system according to claim 36, wherein
the third illuminating unit is arranged outside the one surface of the substrate, and the third imaging unit is adapted to take the images by sensing the light irradiated by the first illuminating unit and transmitted through the substrate.

38. The system according to claim 37, wherein
the third channel further includes a third reflector, wherein the third reflector is arranged outside the another opposite surface of the substrate and is adapted to reflect the light irradiated by the second illuminating unit, transmitted through the substrate and entering into the third reflector, and the third imaging unit is adapted to take images by sensing the light reflected by the third reflector.

39. The system according to claim 36, wherein
the third illuminating unit is arranged outside the one surface of the substrate, and the third imaging unit is adapted to take the images by sensing the light derived from scattering through the substrate of the light irradiated by the third illuminating unit.

40. The system according to claim 36, wherein
the third channel further includes a third reflector, wherein
the third illuminating unit is arranged outside the another opposite surface of the substrate, the third reflector is arranged outside the another opposite surface of the substrate and is adapted to reflect the light that is derived from scattering through the substrate of the light irradiated by the second illuminating unit and then enters into the third reflector, and the third imaging unit is adapted to take the images by sensing the light reflected by the third reflector.

41. The system according to claim 22, wherein
the first illuminating unit is arranged outside the one surface of the substrate, and the first imaging unit is adapted to take the images by sensing the light irradiated by the first illuminating unit and transmitted through the substrate,
the second imaging unit is adapted to take the images by sensing the light derived from scattering through the substrate of the light irradiated by the first illuminating unit, and the third channel further includes a fifth polarization component having a first polarization direction and a sixth polarization component having a second polarization direction orthogonal to the first polarization direction, wherein the third illuminating unit is arranged outside the one surface of the substrate, the fifth polarization component is arranged between the third illuminating unit and the substrate, the sixth polarization component is arranged between the substrate and the third imaging unit, and the third imaging unit is adapted to take the images by sensing the light irradiated by the third illuminating unit and transmitted through the fifth polarization component, the substrate and the sixth polarization component or by sensing the light that is derived from scattering through the substrate of the light irradiated by the third illuminating unit and transmitted through the fifth polarization component and is then transmitted through the sixth polarization component.

42. The system according to claim 41, wherein
the second illuminating unit is arranged outside the one surface of the substrate.

43. The system according to claim 41, wherein
the second channel further includes a second reflector, wherein the second reflector is arranged outside the another opposite surface of the substrate and is adapted to reflect the light that is derived from scattering through the substrate of the light irradiated by the second illuminating unit and then enters into the second reflector, and the second imaging unit is adapted to take images by sensing the light reflected by the second reflector.

44. The system according to claim 41, wherein
the first channel further includes a first reflector, wherein the first reflector is arranged outside the another opposite surface of the substrate and is adapted to reflect the light irradiated by the first illuminating unit, transmitted through the substrate and entering into the first reflector, and the first imaging unit is adapted to take images by sensing the light reflected by the first reflector.

45. The system according to claim 22, wherein
the first imaging unit, the second imaging unit and the third imaging unit are one and the same imaging unit, wherein the images taken by the first imaging unit, the images taken by the second imaging unit and the images taken by the third imaging unit are separated each other in the one and the same imaging unit.

46. The system according to claim 22, wherein
the first imaging unit and the second imaging unit are one and the same imaging unit, wherein the images taken by the first imaging unit and the images taken by the second imaging unit are separated each other in the one and the same imaging unit.

47. The system according to claim 22, wherein
the image processing module is further adapted to detect that the defect is a defect on the substrate, when the positions where the defect appears in the two images are identical or an offset between the positions is equal to a maximum offset, wherein the maximum offset is equal to an offset between positions where a defect located on the one surface of the substrate appears in the two images.

48. The system according to claim 22, wherein
the image processing module is further adapted to detect that the defect is a defect in the substrate, when the positions where the defect appears in the two images are not identical and an offset between the positions is less than a maximum offset, wherein the maximum offset is equal to an offset between positions where a defect located on the one surface of the substrate appears in the two images.

49. A method for detecting and classifying a defect of a substrate, comprising:
setting a first channel, wherein the first channel includes a first illuminating unit adapted to irradiate a light to a transparent or semi-transparent substrate and a first imaging unit adapted to take images by sensing a light from the substrate when the first illuminating unit irradiates the light to the substrate,
setting a second channel, wherein the second channel includes a second illuminating unit adapted to irradiate a light to the substrate and a second imaging unit adapted to take images by sensing a light from the substrate when the second illuminating unit irradiates the light to the substrate,
setting an image constructing module, wherein the image constructing module is adapted to construct two images of the substrate by using the images taken by the first imaging unit and the images taken by the second imaging unit respectively, and
setting an image processing module, wherein the image processing module is adapted to detect, when the substrate has a defect, that the defect is a defect on the substrate or in the substrate, based on a relationship of positions where the defect of the substrate appears in the two images of the substrate.

50. A method for detecting and classifying a defect of a substrate, comprising:
setting a first channel, wherein the first channel includes a first illuminating unit and a first imaging unit, wherein the first illuminating unit is adapted to irradiate a light to a transparent or semi-transparent substrate, and the first imaging unit is arranged outside another opposite surface of one surface of the substrate and is adapted to take images by sensing a light from the substrate when the first illuminating unit irradiates the light to the substrate,
setting a second channel, wherein the second channel includes a second illuminating unit and a second imaging unit, wherein the second illuminating unit is adapted to irradiate a light to the substrate, and the second imaging unit is arranged outside the another opposite surface of the substrate and is adapted to take images by sensing a light from the substrate when the second illuminating unit irradiates the light to the substrate,
setting a third channel, wherein the third channel includes a third illuminating unit and a third imaging unit, wherein the third illuminating unit is adapted to irradiate a light to the substrate, and the third imaging unit is arranged outside the another opposite surface of the substrate and is adapted to take images by sensing a light from the substrate when the third illuminating unit irradiates the light to the substrate,
setting an image constructing module, wherein the image constructing module is adapted to construct three images of the substrate by using the images taken by the first imaging unit, the images taken by the second imaging unit and the images taken by the third imaging unit respectively, and
setting an image processing module, wherein the image processing module is adapted to detect a defect of the substrate by performing image processing on the three images of the substrate, detect that the defect is a defect on the substrate or in the substrate based on a relationship of positions where the defect appears in the two images of the substrate constructed by the images taken by the first imaging unit and the images taken by the second imaging unit respectively, and classify the defect based on different features that the defect appears on the three images of the substrate and that the defect is a defect on the substrate or in the substrate.
